(19) United States
(12) Patent Application Publication
(10) Pub. No.: US 2025/0100804 A1
(43) Pub. Date: Mar. 27, 2025

(54) VERTICAL RECIPROCATING CONVEYER

(71) Applicant: Multilift, Inc., Lakewood, CO (US)

(72) Inventors: Job Bacon-Maldonado, III, Highlands Ranch, CO (US); Job Maldonado, JR., Littleton, CO (US); Kenneth B. Drost, Littleton, CO (US)

(21) Appl. No.: 18/904,987

(22) Filed: Oct. 2, 2024

Related U.S. Application Data
(63) Continuation-in-part of application No. PCT/US24/24007, filed on Apr. 11, 2024.
(63) Continuation-in-part of application No. 18/206,329, filed on Jun. 6, 2023, now Pat. No. 12,129,124.
Application No. 18/206,329 is a continuation of application No. 17/380,993, filed on Jul. 20, 2021, now Pat. No. 11,691,818.
Application No. 17/380,993 is a continuation-in-part of application No. 16/675,105, filed on Nov. 5, 2019, now Pat. No. 11,066,243.
Application No. 16/675,105 is a continuation-in-part of application No. 16/119,804, filed on Aug. 31, 2018, now Pat. No. 10,464,754.
Application No. 16/119,804 is a continuation of application No. 15/673,014, filed on Aug. 9, 2017, now Pat. No. 10,065,801.
Application No. 15/673,014 is a continuation of application No. 15/041,668, filed on Feb. 11, 2016, now Pat. No. 9,745,133.
Application No. 15/041,668 is a continuation of application No. 14/641,126, filed on Mar. 6, 2015, now Pat. No. 9,260,247.
Application No. 14/641,126 is a continuation-in-part of application No. 14/154,141, filed on Jan. 13, 2014, now Pat. No. 9,061,830.
(60) Provisional application No. 63/542,721, filed on Oct. 5, 2023.
(60) Provisional application No. 63/526,150, filed on Jul. 11, 2023.
(60) Provisional application No. 63/458,792, filed on Apr. 12, 2023.
(60) Provisional application No. 63/165,533, filed on Mar. 24, 2021.
(60) Provisional application No. 61/751,722, filed on Jan. 11, 2013.

(51) Int. Cl. B65G 15/44; B07C 5/34; B07C 5/36; B65G 1/04; B65G 15/24; B65G 15/28; B65G 15/58; B65G 17/46; B65G 23/04; B65G 23/22; B65G 41/00

(52) U.S. Cl. CPC B65G 15/44; B07C 5/3412; B07C 5/36; B65G 1/04; B65G 15/28; B65G 15/58; B65G 17/46; B65G 23/04; B65G 23/22; B65G 41/008; B65G 15/24; B65G 41/002; B65G 2201/0273

(57) ABSTRACT

Systems and methods for operating a vertical reciprocating conveyer are provided. The vertical reciprocating conveyer includes a platform configured to receive and support one or more tires. The vertical reciprocating conveyer also includes a vertical lift assembly configured to move the platform between a first floor and a second floor. The vertical reciprocating conveyer also includes a pusher assembly configured to move the one or more tires from the platform to a surface of the second floor.

### CROSS REFERENCE TO RELATED APPLICATIONS

This application is a Continuation-in-Part patent application of and claims the benefit of priority to copending International PCT Patent Application No. PCT/US24/24007, filed Apr. 11, 2024, which claims the benefit of priority to U.S. Provisional Patent Application No. 63/542,721, filed on Oct. 5, 2023, and claims the benefit of priority to U.S. Provisional Patent Application No. 63/526, 150, filed on Jul. 11, 2023, and claims the benefit of U.S. Provisional Patent Application No. 63/458,792, filed on Apr. 12, 2023, the disclosures of each of which are incorporated herein by reference in their entireties.

In addition, this application is a Continuation-in-Part patent application of and claims the benefit of priority to U.S. patent application Ser. No. 18/206,329, filed on Jun. 6, 2023, which is a Continuation Application of and claims the benefit of priority from U.S. patent application Ser. No. 17/380,993, filed on Jul. 20, 2021 (now U.S. Pat. No. 11,691,818, issued Jul. 4, 2023), which claims the benefit of priority from U.S. Provisional Patent Application No. 63/165,533, filed on Mar. 24, 2021, and is also a Continuation-in-Part Application of and claims the benefit of priority from U.S. patent application Ser. No. 16/675,105, filed on Nov. 5, 2019 (now U.S. Pat. No. 11,066,243, issued Jul. 20, 2021), which is a Continuation-In-Part Application of and claims the benefit of priority from U.S. patent application Ser. No. 16/119,804, filed Aug. 31, 2018 (now U.S. Pat. No. 10,464,754, issued Nov. 5, 2019), which is a Continuation Application of and claims the benefit of priority from U.S. patent application Ser. No. 15/673,014, filed on Aug. 9, 2017 (now U.S. Pat. No. 10,065,801, issued Sep. 4, 2018), which is a Continuation Application of U.S. patent application Ser. No. 15/041,668, filed on Feb. 11, 2016 (now U.S. Pat. No. 9,745,133, issued Aug. 29, 2017), which is a Continuation Application of U.S. patent application Ser. No. 14/641,126, filed on Mar. 6, 2015 (now U.S. Pat. No. 9,260,247, issued Feb. 16, 2016), which is a Continuation-in-Part Application of U.S. Patent Application No. 14/154,141, filed on Jan. 13, 2014 (now U.S. Pat. No. 9,061,830, issued Jun. 23, 2015), which claims priority from U.S. Provisional Patent Application No. 61/751,722, filed on Jan. 11, 2013, the disclosures of each of which are incorporated by reference herein in their entireties.

### FIELD

This disclosure relates generally to vertical reciprocating conveyers for automatically moving tires from a first floor to a second floor upon input from a user.

### SUMMARY

Embodiments of the present disclosure are directed to a vertical lift for tires. In some embodiments, the vertical lift may be a Vertical Reciprocating Conveyor (VRC) lift. In other embodiments, the vertical lift may be referred to as an elevator and/or a freight elevator, though it will be appreciated that the elevator and/or the freight elevator refers to an elevator and/or freight elevator that can carry freight, materials, equipment, but not people.

Vertical Reciprocating Conveyors are a classification of freight lifts, or material lifts, governed by the ASME B20.1 Safety Standard, used for moving materials only from one level to another. They provide an efficient, convenient, and safe way to lift and/or convey materials, for example from basements to mezzanines, from mezzanines to basements, and/or between floors, for example in multistory buildings. They are also significantly more cost effective than traditional elevators.

The vertical lift may automatically convey or move one or more tires from a first floor to a second floor based upon input from a user. In other words, upon input from a user (e.g., a user pressing a button), the vertical lift can automatically move a set of tires on a platform from the first floor, which can be any floor of a building or structure, to the second floor, which can be any other floor of the building or structure, eject the set of tires from the platform, and return the platform to the first floor. The one or more tires may include four stacked tires in some embodiments, though in other embodiments the one or more tires may include less than or greater than four tires.

The vertical lift may be fully enclosed. In other embodiments, the vertical lift may be partially enclosed. The vertical lift may be partially or fully enclosed with formed sheet metal panel, which may beneficially reduce or contribute to a smaller horizontal dimension as compared to conventional lifts. In some embodiments the vertical lift can accommodate a stack of tires up to about 55″ vertical height and about 40″ in diameter and/or about 72″ vertical height and about 48″ in diameter, though it will be appreciated that the vertical lift can accommodate a stack of tires of any dimensions. The vertical lift may also have a capacity for at least 500 lbs of weight.

In some embodiments, the vertical lift has a 70″×70″ lift enclosure. In such embodiments, a cutout in the floor is about 78″×78″ to accommodate the vertical lift. Additionally or alternatively, in such embodiments, a basement floor with at least a 24″ recessed concrete slab on a compacted road base may be used to support the vertical lift. To further accommodate the vertical lift, bracing on top floor beams that can be adaptable to side or rear configurations may also be installed to support the vertical lift.

The vertical lift includes a platform configured to support the one or more tires and a wire rope drive system configured to move the platform between a first floor to a second floor (or any number of floors). The platform may be sized so as to accommodate the largest tire that may be conveyed by the vertical lift. The vertical lift also includes a recessed footer anchor plate and a top floor anchor plate to anchor the vertical lift in place. The vertical lift also includes a tire stack pusher configured to push the one or more tires from the platform to the second floor (or any other floor) and the vertical lift can be pneumatically driven. In other embodiments, the tire stack pusher can be a ball screw driven scissor. The tire stack pusher can also operate at a first or lower floor, a second or upper floor, or any number of floors and can be toggled on or off. It will be appreciated that the vertical lift may include more or less components.

The vertical lift may include roll-up doors at a first door of the vertical lift and at a second door of the vertical lift. It will be appreciated that the vertical lift may include any type of door, any combination or doors, or no doors. The vertical lift may also include safety sensors for sensing whether to open or close the door in a safe manner. Similarly, the vertical lift may include strobe lighting for safety that strobes during lift operation so as to indicate that the lift is in use. The vertical lift may also include lighting in an interior space of the lift for lighting the interior of the lift.

The vertical lift may also include a dual I-beam acting as a main support and a dual roller chain drive system to drive the vertical lift. In some embodiments, the drive system can include a fully electric, 3-phase 208V power motor. In other embodiments, the drive system can include any motor. The vertical lift may further include an enclosure with support angles at each corner (e.g., four corners in the illustrated embodiment), which allows for the use of thin-wall side paneling or expanded metal. The vertical lift may be optimized and designed to support a high number of lifting cycles per day.

While specific embodiments and applications have been illustrated and described, the present disclosure is not limited to the precise configuration and components described herein. Various modifications, changes, and variations which will be apparent to those skilled in the art may be made in the arrangement, operation, and details of the methods and systems disclosed herein without departing from the spirit and scope of the overall disclosure.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

In one or more examples, the described methods, processes, and techniques may be implemented in hardware, software, firmware, or any combination thereof. If implemented in software, the functions may be stored as one or more instructions or code on a computer-readable medium and executed by a hardware-based processing unit. Alternatively or additionally, functions may be implemented using machine learning models, neural networks, artificial neural networks, or combinations thereof (alone or in combination with instructions). Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors (e.g., Intel Core i3, i5, i7, or 19 processors; Intel Celeron processors; Intel Xeon processors; Intel Pentium processors; AMD Ryzen processors; AMD Athlon processors; AMD Phenom processors; Apple A10 or 10X Fusion processors; Apple All, A12, A12X, A12Z, or A13 Bionic processors; or any other general purpose microprocessors), graphics processing units (e.g., Nvidia Geforce RTX 2000-series processors, Nvidia Geforce RTX 3000-series processors, AMD Radeon RX 5000-series processors, AMD Radeon RX 6000-series processors, or any other graphics processing units), application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Any of the steps, functions, and operations discussed herein can be performed continuously and automatically. Also, while the flowcharts have been discussed and illustrated in relation to a particular sequence of events, it should be appreciated that changes, additions, and omissions to this sequence can occur without materially affecting the operation of the disclosed embodiments, configuration, and aspects. The embodiments and configurations described herein are neither complete nor exhaustive. As will be appreciated, other embodiments are possible utilizing, alone or in combination, one or more of the features set forth above or described in detail below.

### BRIEF DESCRIPTION OF THE SEVERAL VIEWS OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is an isometric view of a vertical lift according to at least one embodiment of the present disclosure;

FIG. 2 is an isometric view of a vertical lift according to at least one embodiment of the present disclosure;

FIG. 3 is an isometric view of a vertical lift according to at least one embodiment of the present disclosure;

FIG. 4 is an isometric view of a vertical lift according to at least one embodiment of the present disclosure;

FIG. 5 is an isometric view of a vertical lift according to at least one embodiment of the present disclosure;

FIGS. 6A, 6B, and 6C is an isometric view of a vertical lift according to at least one embodiment of the present disclosure;

FIG. 7 is an isometric view of a vertical lift according to at least one embodiment of the present disclosure;

FIG. 8 is an isometric view of a vertical lift according to at least one embodiment of the present disclosure;

FIG. 9 is an isometric view of a vertical lift according to at least one embodiment of the present disclosure;

FIG. 10 is an isometric view of a vertical lift according to at least one embodiment of the present disclosure;

FIG. 11 is an isometric view of a vertical lift according to at least one embodiment of the present disclosure;

FIGS. 12A and 12B is an isometric view of a vertical lift according to at least one embodiment of the present disclosure;

FIG. 13 is an isometric view of a vertical lift according to at least one embodiment of the present disclosure;

FIGS. 14A and 14B is an isometric view of a vertical lift according to at least one embodiment of the present disclosure;

FIG. 15 is an isometric view of a vertical lift according to at least one embodiment of the present disclosure;

FIG. 16 is a block diagram of a system according to at least one embodiment of the present disclosure;

FIG. 17 is a flowchart according to at least one embodiment of the present disclosure; and

FIG. 18 is a flowchart according to at least one embodiment of the present disclosure.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

It should be understood that various aspects disclosed herein may be combined in different combinations than the combinations specifically presented in the description and accompanying drawings. It should also be understood that, depending on the example or embodiment, certain acts or events of any of the processes or methods described herein may be performed in a different sequence, and/or may be added, merged, or left out altogether (e.g., all described acts or events may not be necessary to carry out the disclosed techniques according to different embodiments of the present disclosure). In addition, while certain aspects of this disclosure are described as being performed by a single module or unit for purposes of clarity, it should be understood that the techniques of this disclosure may be performed by a combination of units or modules associated with, for example, a computing device and/or a vertical lift.

In one or more examples, the described methods, processes, and techniques may be implemented in hardware, software, firmware, or any combination thereof. If implemented in software, the functions may be stored as one or more instructions or code on a computer-readable medium and executed by a hardware-based processing unit. Alternatively or additionally, functions may be implemented using machine learning models, neural networks, artificial neural networks, or combinations thereof (alone or in combination with instructions). Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions (for example, the vertical lift) may be executed by one or more processors, such as one or more digital signal processors (DSPs), general purpose microprocessors (e.g., Intel Core i3, i5, i7, or i9 processors; Intel Celeron processors; Intel Xeon processors; Intel Pentium processors; AMD Ryzen processors; AMD Athlon processors; AMD Phenom processors; Apple A10 or 10X Fusion processors; Apple All, A12, A12X, A12Z, or A13 Bionic processors; or any other general purpose microprocessors), graphics processing units (e.g., Nvidia Geforce RTX 2000-series processors, Nvidia Geforce RTX 3000-series processors, AMD Radeon RX 5000-series processors, AMD Radeon RX 6000-series processors, or any other graphics processing units), application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The present disclosure relates to a vertical lift for automatically delivering tires from a first floor to a second floor upon input from a user. In other words, upon input from a user (e.g., a user pressing a button), the vertical lift can automatically move a set of tires on a platform from the first floor to the second floor, eject the set of tires from the platform, and return the platform to the first floor.

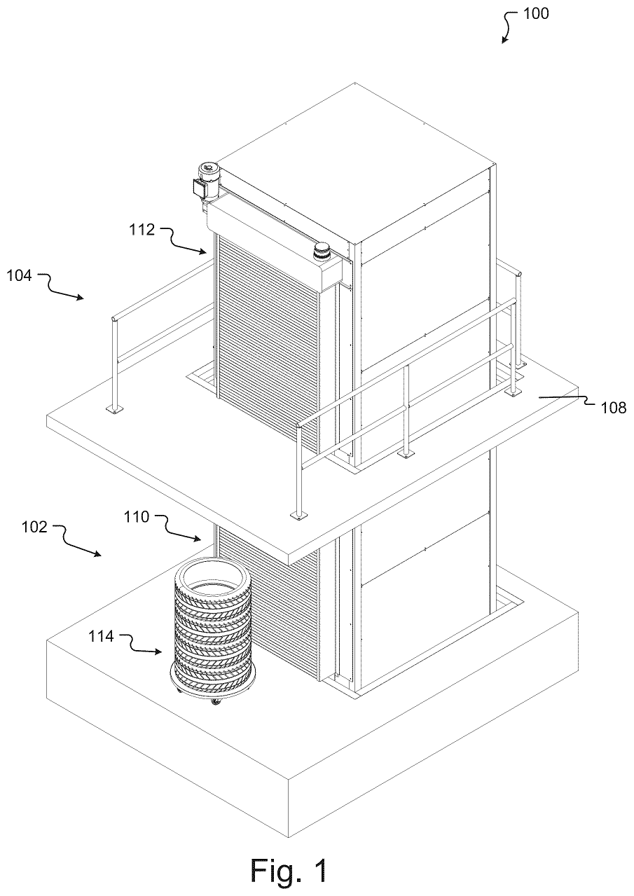

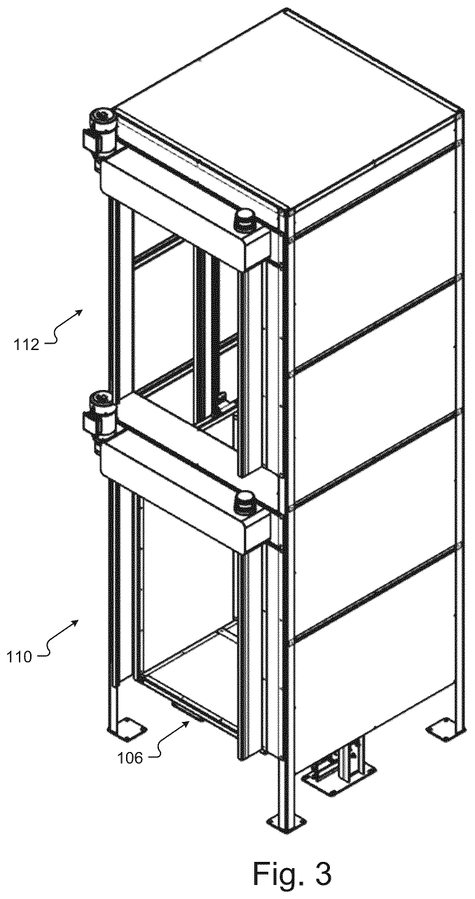

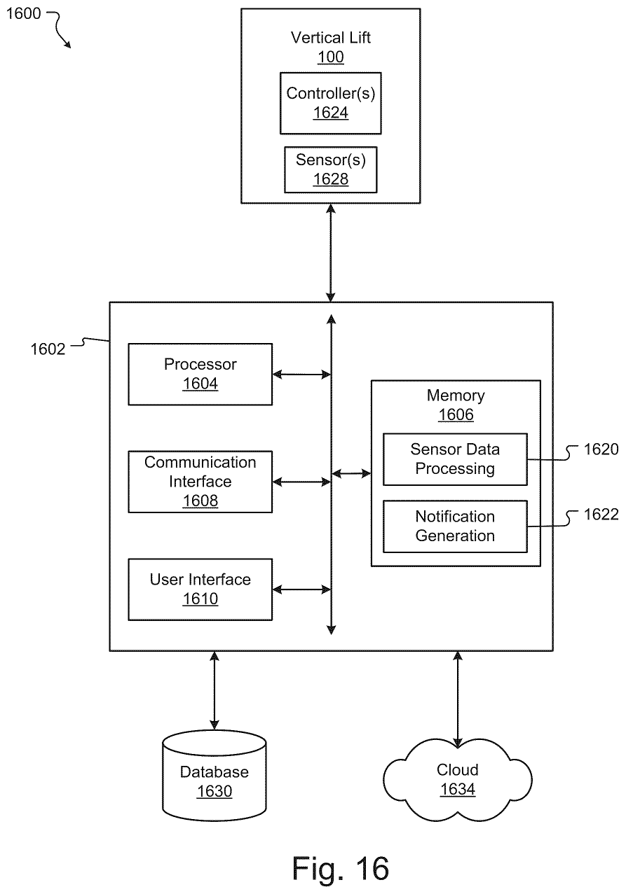

Turning to FIG. 1, a vertical lift 100 with a first floor 102 and a second floor 104 is shown. The vertical lift 100 is configured to automatically deliver a set of tires 114 from the first floor 102 to the second floor 104 based upon input from a user. More specifically, the vertical lift 100 can automatically move the set of tires 114 on a platform 106 (visible in the FIGS. 3, 6A-6C, and 12A-13) from the first floor 102 to the second floor 104, eject the set of tires 114 from the platform 106 to a surface 108 of the second floor 104, and return the platform 106 to the first floor 102. The user input may be received by a user interface 1610 of computing device 1602, as will be discussed in more detail in FIGS. 16-18. In some embodiments the vertical lift 100 can accommodate a set of tires 114 up to about 55″ vertical height and about 40″ in diameter and/or about 72″ vertical height and about 48″ in diameter, though it will be appreciated that the vertical lift 100 can accommodate a set of tires 114 of any diameter.

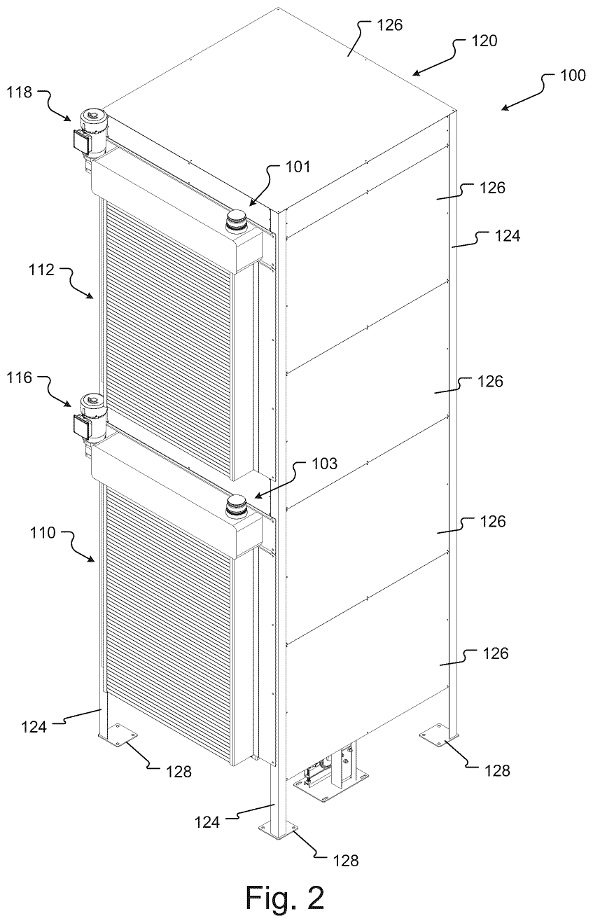

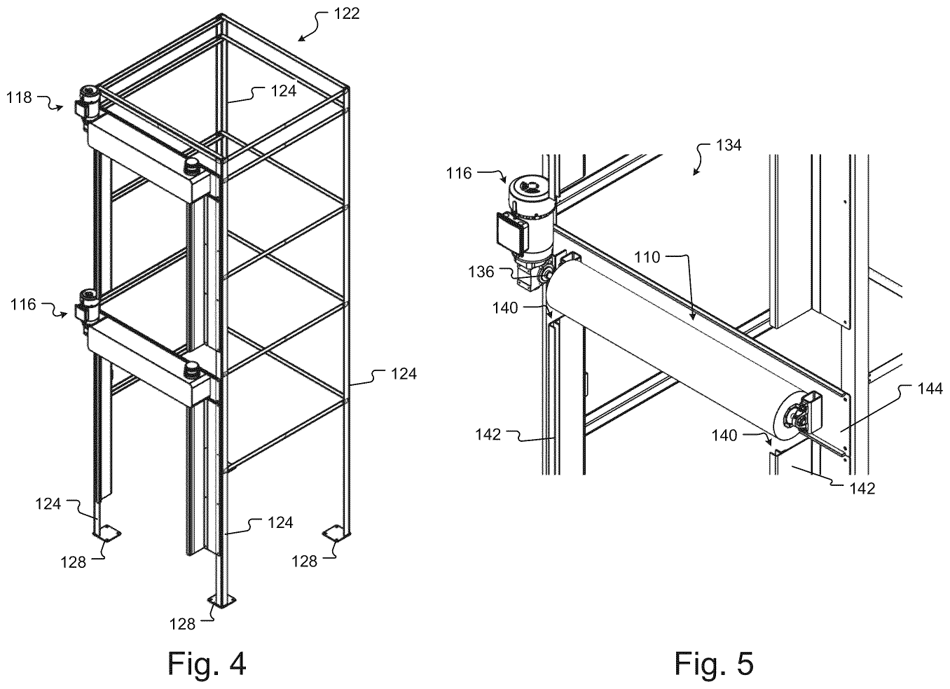

Turning to FIGS. 2-3, the vertical lift 100 is shown in isolation (e.g., without the first floor 102 and the second floor 104). The vertical lift 100 may include a first door 110 positioned at the first floor 102 and a second door 112 positioned at the second floor 104. It will be appreciated that in some embodiments the vertical lift 100 may not include the first door 110 and/or the second door 112. The first door 110 and the second door 112 may each be opened or closed by a first motor 116 and a second motor 118, respectively, as will be discussed in more detail in FIGS. 4-5. The first door 110 and the second door 112 may include a first light 103 and a second light 101, respectively. The first light 103 and the second light 101 may flash or turn on when the first door 116 and/or the second door 118 are in use. The first door 110 and the second door 112 are shown in a closed position in FIG. 2 and an open position in FIG. 3. The first motor 116 and the second motor 118 may be an electric motor, a pneumatic motor, a hydraulic motor, a gear motor, an AC brushless motor, a DC brushed motor, a DC brushless motor, a servo motor, or any other type of motor.

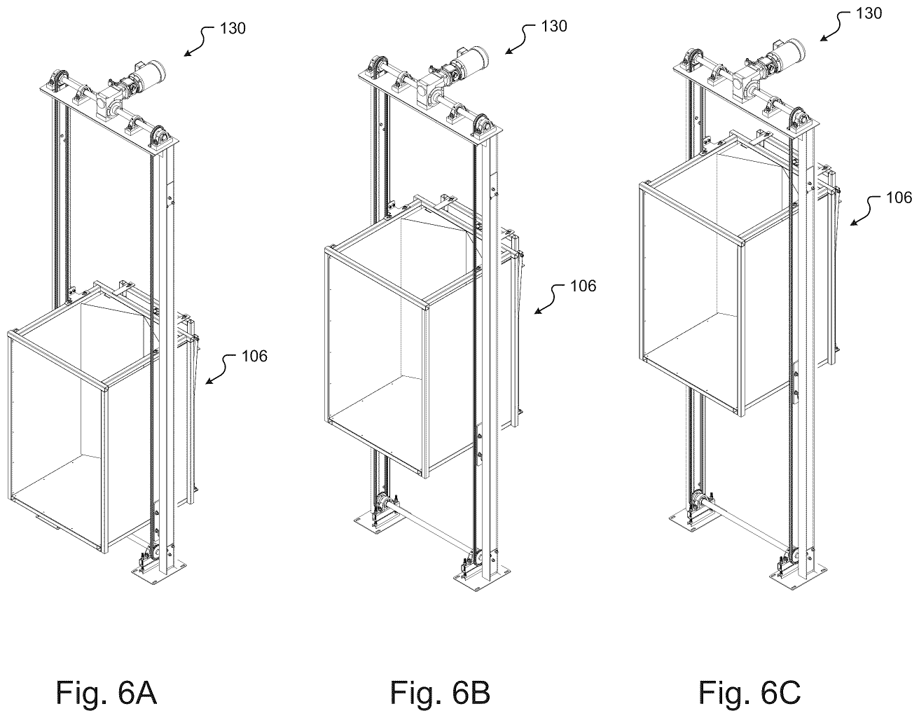

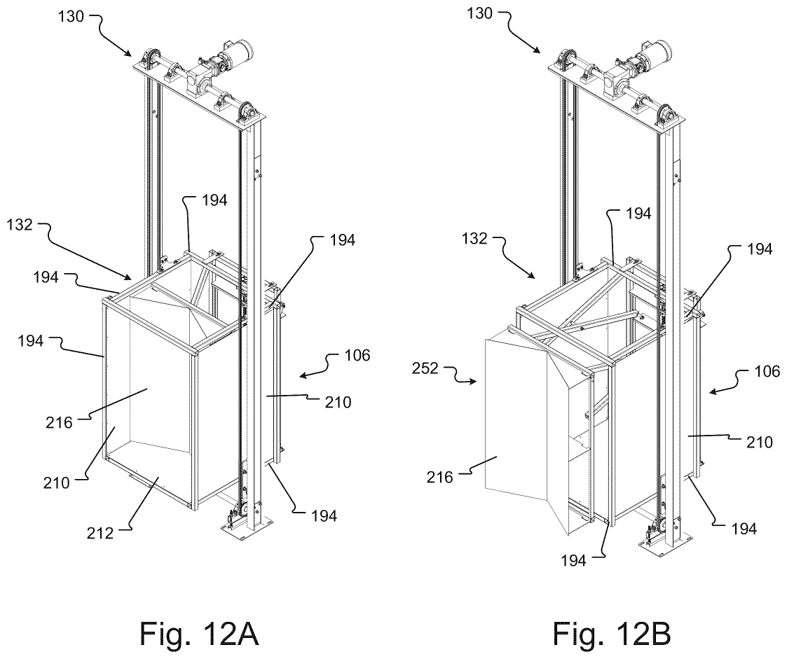

Turning to FIG. 4, a housing 120 of the vertical lift 100 is shown. With reference to FIGS. 2 and 4, the vertical lift 100 may include the housing 120 for enclosing the platform 106, a vertical lift assembly 130 (visible in FIGS. 6A-12B), and a pusher assembly 132 (visible in FIGS. 12A-15). The housing 120 includes a housing structure 122 (shown in FIG. 4), which may be formed from a series of steel tubes 124. In some embodiments, the steel tubes may be square steel tubes, though the steel tubes may be any shape. It will be appreciated that in other embodiments, the housing 120 may be formed from any solid material such as, for example, titanium, metal alloys, aluminum, etc. The housing 120 may also include one or more panels 126 that may be supported on the series of steel tubes 124. The panels 126 may be formed from sheet metal, plastic, or any solid material. The housing 120 also includes one or more base plates 128, which may be secured to a floor such as a concrete floor to secure the housing 120 in place.

With reference to FIG. 5, a detailed view of a door assembly 134 is shown. It will be appreciated that though the door assembly 134 of the first door 110 is shown, a second door assembly may be the same as or similar to the door assembly 134. The door assembly 134 includes the first motor 116 or the second motor 118 that drives a pulley rod 136 connected to a door platform 144. The first door 110 or the second door 112 is mounted to the pulley rod 136. The first door 110 or the second door 112 may be formed from, for example, a plurality of slats that can be rolled up onto the pulley rod 136. In other embodiments, the first door 110 or the second door 112 may be formed of any material capable of being rolled onto the pulley rod 136. The door assembly 134 may also include a gearbox 138 to transfer power from the first motor 116 or the second motor 118 to the pulley rod 136. The door assembly 134 may also include a door slot 140 formed into sheet metal 142 and the door slot 140 is configured to receive an edge of the first door 110 or the second door 112 so as to guide the first door 110 or the second door 112 and keep the first door 110 or the second door 112 aligned when moving between the open position and the closed position. The door assembly 134 may include a pair of door slots 140 positioned opposite each other and on either side of the first door 110 or the second door 112 so that opposite edges of the first door 110 or the second door 112 can be guided and kept in alignment. It will be appreciated that in some embodiments, the door assembly 134 may not include a door slot 140 or may include one door slot 140, two door slots 140, or more than two door slots 140.

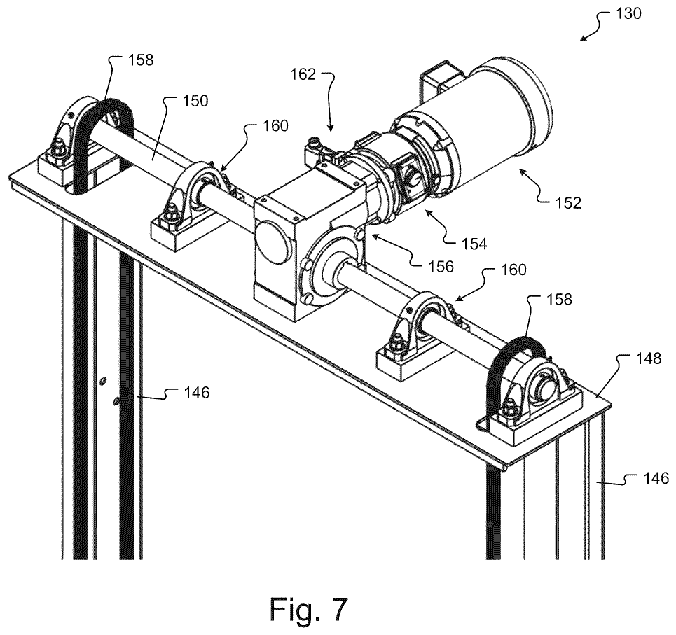

Reference will now be made to FIGS. 6A-11 and the vertical lift assembly 130. Turning to FIGS. 6A-6C, the platform 106 is shown in a first position, a second position, and a third position, respectively. As shown, the platform 106 can be moved vertically using the vertical lift assembly. Turning to FIG. 7, a detailed view of a top portion of the vertical lift assembly 130 is shown. The vertical lift assembly 130 includes two I-beams 146 for supporting vertical movement of the platform 106 and a motor platform 148 positioned at an end of the two I-beams 146. The motor platform 148 is configured to support a motor 152 that rotates a first shaft 150, which may be, for example a drive shaft. The motor 152 may be an electric motor, a pneumatic motor, a hydraulic motor, a gear motor, an AC brushless motor, a DC brushed motor, a DC brushless motor, a servo motor, or any other type of motor.

As shown, the drive shaft 150 is supposed by one or more bearings 160. In the illustrated embodiment, the drive shaft 150 is supported by four bearings, though it will be appreciated that in other embodiments the drive shaft 150 may be supported by one bearing, two bearings, or more than two bearings. The drive shaft 150 rotates a pair of roller cables 158 that are connected to the platform 106. The platform 106 is configured to move in a first vertical direction when the roller cables 158 are rotated in a first direction and is configured to move in a second vertical direction when the roller cables 158 are rotated in a second direction.

The vertical lift assembly 130 also includes a gearbox 156 for transferring the power from the motor 152 to the drive shaft 150 and an encoder 154 for controlling a speed of the motor 152. The vertical lift assembly 130 may also include a mechanical brake or a holding brake 162 to hold the platform 106 in place when the platform 106 is not moving.

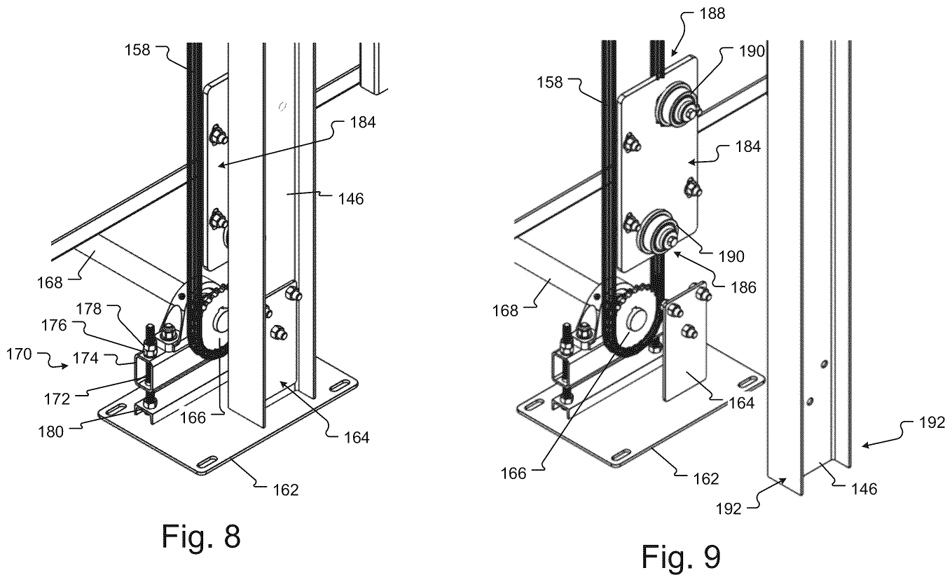

Turning to FIGS. 8 and 9, a bottom portion of the vertical lift assembly 130 is shown with the I-beam 146 in place and with the I-beam 146 spaced apart from the roller chain 158, respectively. As shown, the vertical lift assembly 130 includes a base platform 162 at the end of each I-beam 146. The base platform 162 can be bolted or otherwise secured to the floor (e.g., a concrete floor) to secure the vertical lift assembly 130 to the floor. Also shown, the I-beam 146 may be connected to the base platform 162 by a base connector plate 164. A portion of the base connector plate 164 may be welded to the base platform 162 and another portion of the base connector plate 164 may be bolted to the I-beam 146. The base connector plate 164 enables the vertical lift assembly 130 to be modular and results in easier manufacturing, shipping, and installation.

As further shown, the roller chain 158 is connected to a sprocket 166 at an end of a second shaft 168, which may be, for example, a driven shaft. It will be appreciated that second roller chain 158 of the pair of roller chains 158 may also be connected to a sprocket at another end of the second shaft 168. The second shaft 168 and sprockets 168 are supported by a tension assembly 170 for tensioning the roller chain 158. The tension assembly 170 includes a threaded rod 172 fixed at end to a base 180 of the tension assembly 170. The threaded rod 172 extends through and from a tubing 174 (which may be, for example, steel). A first nut 176 and a second nut 178 are screwed onto the threaded rod 172 and can be used to adjust a tension of the roller chain 158. For example, the first nut 176 may be rotated to pull the roller chain 158 downward until the roller chain 158 is at a desired or target tension. The second nut 178 may then be rotated and tightened against the first nut 176 to lock the first nut 176 in place. Each roller chain 158 may be tensioned simultaneously or sequentially.

The I-beam 146 is shown spaced from the roller chain 158 in FIG. 9 to highlight the connector plate 184. The connector plate 184 connects the platform 106 to the vertical lift assembly 130. The connector plate 184 may be, for example, bolted to the platform 106 (whether to a panel, a steel tube, or any portion of the platform 106) or otherwise connected to the platform 106. Though not shown, the connector plate 184 may include one or more slots where the connector plate 184 is bolted to the platform 106. The slots may be used to level the platform 106 relative to the vertical lift assembly 130. The connector plate 184 may also be directly connected to the roller chain 158. In other words, the roller chain 158 may be connected at a first end 186 to a first end of the connector plate 184 and a second end 188 to a second end of the connector plate 184. In some embodiments, the roller chain 158 is connected to the connector plate 184 by a hardened pin and a bushing disposed in an aperture formed in the connector plate 184. Thus, as the roller chain 158 is rotated, the connector plate 184 (and the platform 106) moves with the roller chain 158. To keep the platform 106 aligned with the I-beams 146, a pair of rollers 190 are attached to the connector plate 184. The pair of rollers 190 fit between and roll between two flanges 192 of the I-beam 146 and keep the platform 106 aligned with the I-beams 146.

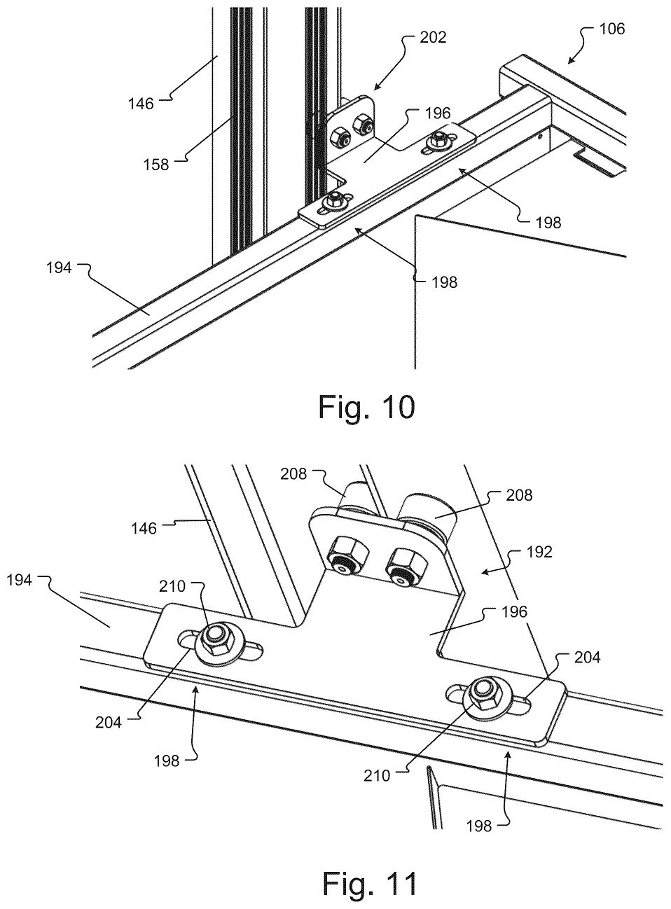

Turning to FIGS. 10-11, a first detailed view and a second detailed view of a stabilizer 196 are respectively shown. The stabilizer 196 may be used to stabilize the platform 106 relative to the vertical lift assembly 130. While the connector plate 184 connects the platform to the roller chain 158 near a bottom portion of the platform 106, the stabilizer 196 stabilizes the platform 106 near a top portion of the platform 106. The stabilizer 196 includes a first portion 202 connected to the platform 106 and a second portion 198. The first portion 202 may be fixed to, for example, a platform frame 194 of the platform 106. The first portion includes a pair of slots 204 through which a pair of corresponding bolts 210 can pass through. The pair of slots 204 enable the platform 106 to be adjusted forward or backwards to level the platform 106. The second portion 198 includes a pair of rollers 208 where one roller 208 is positioned between the two flanges 192 of the I-beam 146 and another roller 208 is positioned outside of one of the two flanges 192 of the I-beam 146. The stabilizer 196 beneficially keeps the platform 106 more rigid and offsets the weight on the backend of the platform 106.

Reference will now be made to FIGS. 12A-15 and the pusher assembly 132.

Turning to FIGS. 12A-12B, the pusher assembly 132 in a first position and a second position are respectively shown. The pusher assembly 132 may be positioned in the platform 106. The platform 106 may include the platform frame 194 and one or more platform panels 210. The platform frame 194 may be formed from one or more tubes, which may be, for example, steel tubes, aluminum tubes, or any other solid tubing material. A footprint 212 of the platform 106 may be sized so as to fit a stack of tires. In other words, the footprint 212 may be larger than a diameter of the stack of tires. Similarly, a height of the platform 106 may be equal to or greater than a height of the stack of tires.

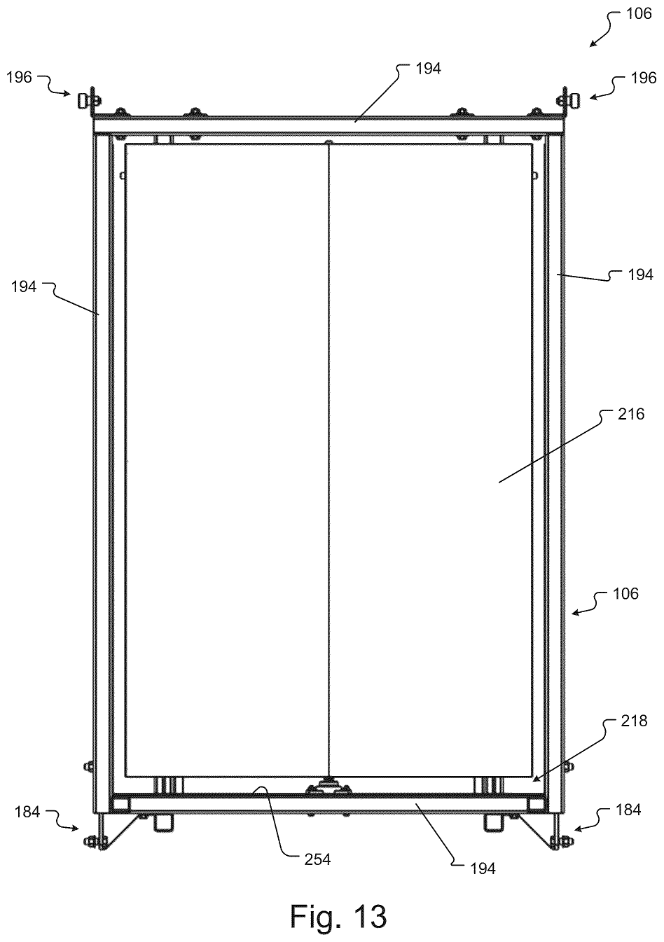

The pusher assembly 132 includes a pusher 252 that is movable between the first position and the second position by a pair of scissor arms 220. The pusher 252 includes a V-shaped surface 216 so as to align and stabilize the stack of tires during movement. As shown in FIG. 13, a gap 218 is formed between the pusher 252 and a bottom platform surface 254. The gap 218 may ensure that the pusher 252 does not catch on the bottom platform surface 254.

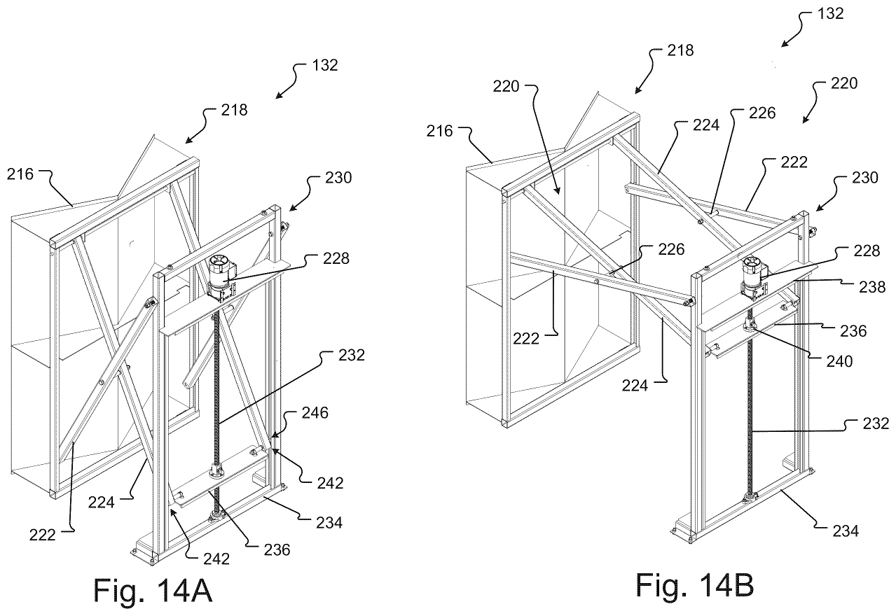

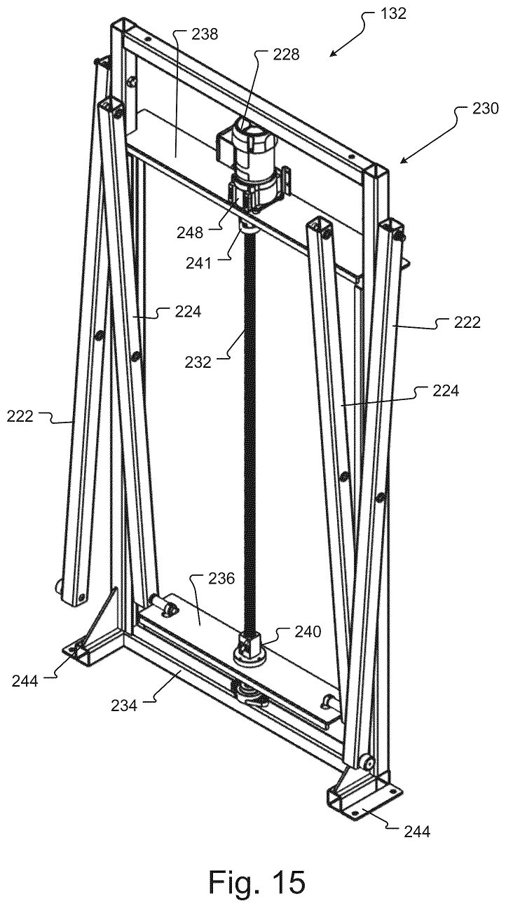

Turning to FIGS. 14A-14B, the pusher assembly 132 in isolation is shown in the first position and the second position, respectively, and in FIG. 15, the pusher assembly 132 is shown without the pusher 252. As previously described, the pusher assembly 132 includes the pair of scissor arms 220. The pair of scissor arms 220 are formed by a first arm 222 and a second arm 224 connected at a hinge 226. The pair of scissor arms 220 are actuated by a pusher motor 228 mounted on a pusher platform 106 and attached to a pusher frame 230. The pusher assembly 132 may also include a pusher encoder 248 (labelled in FIG. 15) for controlling a speed of the pusher motor 228. The pusher motor 228 may be an electric motor, a pneumatic motor, a hydraulic motor, a gear motor, an AC brushless motor, a DC brushed motor, a DC brushless motor, a servo motor, or any other type of motor. In some embodiments, the pusher assembly 132 may be pneumatically actuated.

The pusher frame 230 includes a pusher base 244 that can be bolted to the platform 106. The pusher motor 228 rotates a screw 232 attached to the pusher frame 230 via a coupler 241 (shown in FIG. 15). The screw 232 may be, for example, a ball screw. When the screw 232 rotates, a scissor arm platform 106 is moved linearly. More specifically, the scissor arm platform 106 includes a threaded nut 240 attached to the screw 232 and a pair of rollers 242. The threaded nut 240 may internally include bearing balls that circulate around the threads of the screw 232, thereby reducing friction when the threaded nut 240 moves along the screw 232.

The pair of rollers 242 are disposed in corresponding tracks 246 formed in the pusher frame 230. The pair of rollers 242 enable the scissor arm platform 106 to linearly move up and down the pusher frame 230 and keep the scissor arm platform 106 aligned to the pusher frame 230. The second arms 224 are connected to the scissor arm platform 106 and the first arms 222 are fixed to the pusher frame 230. Thus, when the pusher motor 228 rotates the screw 232 in a first direction, the scissor arm platform 106 moves in a first linear direction via the threaded nut 240, which in turn moves the second arms 224 and the pusher 252 in a first horizontal direction relative to the pusher frame 230. Similarly, when the pusher motor 228 rotates the screw 232 in a second direction, the scissor arm platform 106 moves in a second linear direction via the threaded nut 240, which in turn moves the second arms 224 and the pusher 252 in a second horizontal direction relative to the pusher frame 230.

It will be appreciated that any motor (e.g., the first motor 116, the second motor 118, the motor 130, the pusher motor 228) may include a worm drive gear. It will also be appreciated that any motor (e.g., the first motor 116, the second motor 118, the motor 130, the pusher motor 228) may be a variable frequency drive (VFD) motor. Further, any motor (e.g., the first motor 116, the second motor 118, the motor 130, the pusher motor 228) may include a build in brake for holding, for example, the platform 106, the first door 110, the second door 110, and/or the pusher 252.

It will also be appreciated that any component described herein may be formed of any material such as, for example, steel, aluminum, titanium, a metal alloy, or any metal. For example, any tubing or support system may be formed from steel. In another example, the I-beams may be formed from steel I-beams. In still another example, any panel described herein may be formed from metal sheets.

The vertical lift 100 may operate and perform a series of steps automatically using, for example, one or more sensors, one or more controllers, one or more processors, etc. as will be described in detail below.

Turning to FIG. 16, a block diagram of a system 1600 according to at least one embodiment of the present disclosure is shown. The system 1600 may be used to optimize use of a vertical lift such as the vertical lift 100 or one or more other aspects of one or more of the methods disclosed herein. The system 1600 comprises a computing device 1602, the vertical lift 100, a database 1630, and/or a cloud or other network 1634. Systems according to other embodiments of the present disclosure may comprise more or fewer components than the system 1600. For example, the system 1600 may not include one or more components of the computing device 1602, the database 1630, and/or the cloud 1634.

The computing device 1602 comprises a processor 1604, a memory 1606, a communication interface 1608, and a user interface 1610. Computing devices according to other embodiments of the present disclosure may comprise more or fewer components than the computing device 1602.

The processor 1604 of the computing device 1602 may be any processor described herein or any similar processor. The processor 1604 may be configured to execute instructions stored in the memory 1606, which instructions may cause the processor 1604 to carry out one or more computing steps utilizing or based on data received from the vertical lift 100 and more specifically, one or more sensors 1628, one or more controllers 1624, or any of the encoders and/or motors of the vertical lift 100.

The memory 1606 may be or comprise RAM, DRAM, SDRAM, other solid-state memory, any memory described herein, or any other tangible, non-transitory memory for storing computer-readable data and/or instructions. The memory 1606 may store information or data useful for completing, for example, any step of the method 400 described herein, or of any other methods. The memory 1606 may store, for example, instructions and/or machine learning models that support one or more functions of the vertical lift 100. For instance, the memory 1606 may store content (e.g., instructions and/or machine learning models) that, when executed by the processor 1604 or the controller 1624, enable sensor data processing 1620 and/or notification generation 1622.

The sensor data processing 1620 enables the processor 1604 to process sensor data (received from for example, the sensor 1628). The processed sensor data may include, for example, pressure value(s), acceleration value(s), force value(s), vibration value(s), etc.

The notification generation 1624 enables the processor 1604 to generate a notification when the processed sensor data meets or exceeds a predetermined threshold. It will be appreciated that in some embodiments, the notification may be generated when the processed sensor data is below the predetermined threshold. In still other embodiments, the notification may be generated when a difference between the processed sensor data and an expected sensor data meets or exceeds the predetermined threshold. The notification may be an audible and/or a visual notification (which may be displayed on, for example, the user interface 1610).

Such content, if provided as in instruction, may, in some embodiments, be organized into one or more applications, modules, packages, layers, or engines. Alternatively or additionally, the memory 1606 may store other types of content or data (e.g., machine learning models, artificial neural networks, deep neural networks, etc.) that can be processed by the processor 1604 to carry out the various method and features described herein. Thus, although various contents of memory 1606 may be described as instructions, it should be appreciated that functionality described herein can be achieved through use of instructions, algorithms, and/or machine learning models. The data, algorithms, and/or instructions may cause the processor 1604 to manipulate data stored in the memory 1606 and/or received from or via the controller 1624, the sensor 1628, database 1630, and/or the cloud 1634.

The computing device 1602 may also comprise a communication interface 1608. The communication interface 1608 may be used for receiving sensor data or other information from an external source (such as the controller 1624, the sensor 1628, the database 1630, the cloud 1634, and/or any other system or component not part of the system 1600), and/or for transmitting instructions, images, or other information to an external system or device (e.g., another computing device 1602, the controller 1624, the sensor 1628, the database 1630, the cloud 1634, and/or any other system or component not part of the system 1600). The communication interface 1608 may comprise one or more wired interfaces (e.g., a USB port, an Ethernet port, a Firewire port) and/or one or more wireless transceivers or interfaces (configured, for example, to transmit and/or receive information via one or more wireless communication protocols such as 802.11a/b/g/n, Bluetooth, NFC, ZigBee, and so forth). In some embodiments, the communication interface 1608 may be useful for enabling the device 1602 to communicate with one or more other processors 1604 or computing devices 1602, whether to reduce the time needed to accomplish a computing-intensive task or for any other reason.

The computing device 1602 may also comprise one or more user interfaces 1610. The user interface 1610 may be or comprise a keyboard, mouse, trackball, monitor, television, screen, touchscreen, and/or any other device for receiving information from a user and/or for providing information to a user. The user interface 1610 may be used, for example, to receive a user selection (e.g., start the vertical lift 100) or other user input regarding any step of any method described herein. Notwithstanding the foregoing, any required input for any step of any method described herein may be generated automatically by the system 1600 (e.g., by the processor 1604, the controller 1624, or another component of the system 1600) or received by the system 1600 from a source external to the system 1600. The user interface 1610 may also be used to display, for example, a notification.

Although the user interface 1610 is shown as part of the computing device 1602, in some embodiments, the computing device 1602 may utilize a user interface 1610 that is housed separately from one or more remaining components of the computing device 1602. In some embodiments, the user interface 1610 may be located proximate one or more other components of the computing device 1602, while in other embodiments, the user interface 1610 may be located remotely from one or more other components of the computer device 1602.

The vertical lift 100 may include the controller 1624, which may be an electronic, a mechanical, or an electro-mechanical controller. The controller 1624 may comprise or may be any processor described herein. The controller 1624 may comprise a memory storing instructions for executing any of the functions or methods described herein as being carried out by the controller 1624. In some embodiments, the controller 1624 may be configured to simply convert signals received from the computing device 1602 (e.g., via a communication interface 1608) into commands for operating the vertical lift 100. In other embodiments, the controller 1624 may be configured to process and/or convert signals received from the sensor 1628. Further, the controller 1624 may receive signals from one or more sources (e.g., the sensor 1628, the computing device 1602) and may output signals to one or more sources.

The vertical lift 100 may also include the sensor 1628, which may be configured to sense at least one value of the vertical lift 100 and yield sensor data. More specifically, the sensors 1628 may be positioned anywhere on the vertical lift 100 such as, for example, the first door 110 and/or the second door 112, at any motor (e.g., the first motor 116, the second motor 118, the motor 130, the pusher motor 228), at the platform 106, and/or at the pusher assembly 132. The sensor 1628 may correspond to transducers that are configured to convert physical phenomena into an electrical signal that is capable of being processed by the controller 1624 or the processor 1604 of the computing device 1602. Non-limiting examples of the sensor 1628 include optical sensors, gyroscopic sensor, pressure sensor, accelerometers, strain gauges, impact sensor, vibration detectors, etc. The sensor 1628 may include one or more or any combination of components that are electrical, mechanical, electro-mechanical, magnetic, electromagnetic, or the like. In some embodiments, the sensor 1628 may include a memory for storing sensor data. In still other examples, the sensor 1628 may output signals (e.g., sensor data) to one or more sources (e.g., the controller 1624, the computing device 1602, etc.).

The database 1630 may store information that correlates to one or more parameters of the vertical lift 100. For example, the database 1630 may store information regarding an optimal speed for the motor 130 based on a weight of the platform 106 and a set of tires. The database 1630 may also store one or more algorithms for determining and controlling a speed of the motor 130 (or any motor).

The cloud 1634 may be or represent the Internet or any other wide area network. The computing device 1602 may be connected to the cloud 1634 via the communication interface 1608, using a wired connection, a wireless connection, or both. In some embodiments, the computing device 1602 may communicate with the database 1630 and/or an external device (e.g., a computing device) via the cloud 1634.

The system 1600 or similar systems may be used, for example, to carry out one or more aspects of any of the methods 1700, 1800 described herein. The system 1600 or similar systems may also be used for other purposes.

### Automated Tire Replacement Systems

In some embodiments, a vertical reciprocating conveyer (VRC) is part of a system for efficiently replacing tires. A VRC can enhance efficiency of a tire replacement system. For example, a VRC can transport tires within a facility, such as from one floor to another. The VRC facilitates efficient transfer of tires from one area to another, such as from a storage area to a tire replacement area, from a tire replacement area to a disposal area, from a tire replacement area to a tire storage area, and/or to and/or from other areas. A VRC with a pusher can transport tires from area to another, for example by being loaded with tires at a first floor, moving the tires to a second floor, and pushing the tires from the VRC at the second floor. A VRC can transport tires up and/or down, for example to a ground floor to an above-ground floor, a below-ground floor to a ground floor, a below ground floor to an above-ground floor, an above-ground floor to a ground floor, an above-ground floor to a below-ground floor, and/or combinations thereof.

A VRC can be part of a system for removing, installing, and/or replacing tires. Examples of such systems are disclosed in PCT Patent Application Publication Numbers WO 2019/204552 A1 (entitled “Automated removal and replacement of vehicle wheels and tires”), WO 2021/076532 A1 (entitled “Automated removal and replacement of vehicle wheels and tires”), and WO 2023/076558 A1 (entitled “Robotic apparatus interaction with vehicle based on vehicle dimension translation”), and U.S. Patent Application Publication Numbers US 2020/0108659 A1 (entitled “Automated removal and replacement of vehicle wheels and tires”) and US 2021/0114408 A1 (entitled “Automated removal and replacement of vehicle wheels and tires”), each of which is incorporated by reference herein in their entirety.

In some embodiments, a VRC is used in a tire replacement system that is at least partially automated. For example, a VRC can be used in a tire replacement system with automated transport of tires. For example, a robot, such as an autonomous robot can be used to transport tires to and/or from a VRC. In some embodiments of the conveyor system, humans may load articles or tires onto the conveyor (typically the bottom of the conveyor) and unload articles or tires off of the conveyor (typically the top of the conveyor) as a part of the system. In various embodiments, one or more persons load the tires and a different one or more persons unload the tires or articles. In alternate embodiments, machines or robots may load and unload the articles and tires. In additional embodiments a combination of humans, robots, and machines may be used to load and unload the articles or tires.

Lean manufacturing principles may be applied throughout embodiments of the disclosure to facilitate efficiency in tire loading, unloading, and/or storage. For example, in one embodiment, value stream mapping is used to analyze logistics data provided by a company to create Pareto analysis to identify high volume, high turn-over tire SKUs (i.e., stock control units). A manufacturing plant analysis is implemented to determine the capacity and production rate of a given customer to determine the size, capacity, number, and/or breadth of tire loading, unloading and/or storage needed to fulfill capacity and production goals. For example, for higher customer inventory levels, fully-automated loading, unloading and/or storage systems may be desired. However, for lower inventory levels, customers may use partially-automated loaders, unloaders, and/or storage systems to maximize efficiency and lower overall costs.

In yet other embodiments, the systems and methods of the present disclosure are facilitated by one or more human and/or computerized operators. For example, an operator monitors robot loaders and/or unloaders, monitors system settings and/or identifies racks that require replacement or repair. Operators also drive forklifts, load/unload tires, and/or the like to facilitate overall system usage.

One aspect of embodiments of the present disclosure is to provide a system capable of handling all sizes of vehicle tires, providing maximum compression of tires, and minimizing the manual labor required for loading, unloading, stacking, and/or storing the articles or tires.

In some embodiments of the system, tires are ricked or stacked in a herringbone pattern to facilitate compression and/or space management. The system and method also includes the stacking of tires in any other suitable arrangement that would allow the transport rack to perform similar functions. Moreover, the system and method may include any variation or angle of herringbone patterns that would allow the transport rack to perform similar functions as disclosed herein.

As one with ordinary skill in the art appreciates, the proper alignment of tires in the herringbone pattern depends upon the geometry of tires being stacked. Thus, the system contemplates and accommodates incorporation of an automated system for control of the loader system. The control system automatically senses tire geometry based on sensors located at an upstream position on the conveyor, or alternatively, accommodates the manual input of information. In both cases, however, the control system uses information that is indicative of tire geometry, such as outside diameter, inside diameter, and/or tread width, to determine the rotation and translation of each tire to produce the desired stacking pattern. With respect to herringbone stacking patterns, the relevant output variables may include the angle of deviation from vertical associated therewith the axis of rotation of tires in successive rows as well as the number of tires in each row and the number of rows in each stack. Furthermore, the control system may determine the appropriate amount of compression to apply to the stacked load, and the corresponding number of rows in the stack, to avoid permanent deformation of tires. The control system may consider a variety of factors in determining the appropriate compressive loads to apply. In one embodiment, these factors include the material properties and/or hardness of tires (usually rubber), tire geometry and stacked orientation, and the time and temperature environment to which compressed tires will be subjected. In addition, empirical data and experience may be incorporated to optimize the control of the system.

As used herein, warehouse racks include any type of rack that is distinct, including for example, pallets, racks such as those manufactured by Ohio Rack, Inc., or the like.

In some embodiments, the conveyor system may comprise one or more scanners to facilitate identifying each tire or article. For example, in one embodiment, the system comprises two scanners configured on both sides of a two-lane conveyor. The scanners may be configured both above and below the conveyor and/or articles to facilitate reading the articles' labels/SKUs. In alternate embodiments, the scanner may be a barcode scanner, a radio-frequency scanner, optical scanners, vision systems and/or any other type of scanner for reading and/or identifying tire or article labels and/or SKUs. The scanner may be configured with a CPU and/or any other computing system or unit. The scanner may also be configured to communicate with the rack loading system, conveyor, and/or any other part of the system or any other system described herein. Alternatively, RFID tags and readers may be used with the system.

In one embodiment, each tire on a conveyor and/or a warehouse storage area is the same type, size, and/or SKU number, or may be designated for the same destination or storage area. Tires may be delivered to storage areas and/or a warehouse rack on a conveyor. In additional or alternative embodiments, articles and tires may be delivered to storage areas and/or a warehouse rack on two or more conveyors. Further, the tire or article may be scanned and identified then loaded on to the appropriate conveyor for storage in the appropriate area. Thus, one type of tire may be loaded onto one conveyor to be stored in a first area and a different type of tire or article may be loaded onto a second conveyor to be stored in a second area that is different from the first area.

In some embodiments, the conveyor system and the rack loading system may also be configured to stack tires or articles based upon identification information received from the scanner. For example, in one embodiment, the rack loading system may be configured to receive tire identification information from the scanner and to use the tire identification information to determine what tire stacking configuration to use. That is, for smaller diameter tires, the rack loading system may stack tires in layers of five tires, for example. For larger diameter tires, the rack loading system may stack tires in layers of four tires, for example.

In various embodiments, the one or more conveyors may elevate the tires to a stop position in front of one or more position pick-and-place loaders. The pick-and-place loaders can each comprise a support-mounted actuator system, each of which controls an extendable/retractable arm that is adapted to seize the tire or article from the conveyor.

In another embodiment, some conveyors may be configured with one or more scanners to obtain tire identifying information to facilitate sorting and queuing the tires. The scanners may be configured like scanners and communicate with the conveyors to facilitate directing each SKU of tire to a different sub-conveyor for loading into a particular area, such as a storage area. Each area is configured to hold between 10 and 30 tires of a single SKU.

In one embodiment, a queuing system may comprise an inbound queue of tires or articles that have been unloaded from a trailer, railcar, forklift and/or other transportation mechanism. For example, a number of tires or articles are queued on each side of the queuing system.

In various embodiments, the system may also be configured with a control panel to facilitate worker operation of the conveyor. For example, the worker may use a panel to raise or lower the conveyor in order to facilitate access to tires, storage areas, and racks. In another embodiment, a load station may be configured with one or more scanners or cameras to detect the height of rack, storage floor, storage area, tires, and the conveyors and raise or lower the conveyor based on whether the height of the racks, tires, storage floor, storage area, or conveyor meets a predetermined height.

The scanner computing unit or any other computing unit used or described herein may be connected with each other via a data communication network. The network may be a public network and assumed to be insecure and open to eavesdroppers. In the illustrated implementation, the network is embodied as the Internet. In this context, the computers may or may not be connected to the Internet at all times. For example, the customer computer may employ a modem to occasionally connect to the Internet, whereas the bank computing center might maintain a permanent connection to the Internet. Specific information related to the protocols, standards, and application software utilized in connection with the Internet may not be discussed herein. For further information regarding such details, see, for example, Dilip Naik, “Internet Standards and Protocols” (1998); “Java 2 Complete,” various authors (Sybex 1999); Deborah Ray and Eric Ray, “Hosting HTML 4.0” (1997); Loshin, “TCP/IP Clearly Explained” (1997). All of these texts are incorporated by reference herein in their entireties.

It may be appreciated that many applications of the present disclosure may be formulated. One skilled in the art may appreciate that a network may include any system for exchanging data or transacting business, such as the Internet, an intranet, an extranet, DSL, WAN, LAN, Ethernet, satellite communications, and/or the like. It is noted that the network may be implemented as other types of networks, such as an interactive television (ITV) network. The users may interact with the system via any input device such as a keyboard, mouse, kiosk, smart phone, e-reader, tablet, laptop, Ultrabook™, personal digital assistant, handheld computer (e.g., Palm Pilot®), cellular phone, or the like. Similarly, embodiments of the disclosure could be used in conjunction with any type of personal computer, network computer, workstation, minicomputer, mainframe, smart phone, etc. Moreover, although embodiments frequently are as being implemented with TCP/IP communications protocols, it may be readily understood that embodiments may also be implemented using IPX, Appletalk, IP-6, NetBIOS, OSI or any number of existing or future protocols. Moreover, the present disclosure contemplates the use, sale or distribution of any goods, services or information over any network having similar functionality described herein.

In accordance with various embodiments of the disclosure, the Internet Information Server, Microsoft Transaction Server, and Microsoft SQL Server, may be used in conjunction with the Microsoft operating system, Microsoft NT web server software, a Microsoft SQL database system, and a Microsoft Commerce Server. Additionally, components such as Access or SQL Server, Oracle, Sybase, Informix MySQL, Interbase, etc., may be used to provide an ADO-compliant database management system. The term “webpage” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and/or the like.

A system user may interact with the system via any input device such as, a keypad, keyboard, mouse, kiosk, smart phone, e-reader, tablet, laptop, Ultrabook™, personal digital assistant, handheld computer (e.g., Palm Pilot®, Blackberry®, iPhone®, iPad®, Android®), cellular phone, or the like. Similarly, embodiments could be used in conjunction with any type of personal computer, network computer, work station, minicomputer, mainframe, smart phone, tablet, or the like running any operating system such as any version of Windows, MacOS, iOS, OS/2, BeOS, Linux, UNIX, Solaris, MVS, tablet operating system, smart phone operating system, or the like, including any future operating system or similar system.

In some embodiments, a tire changing system includes various actions and/or means for carrying out actions, including but not limited to, job scheduling, tire selection, vehicle check in, wheel assessment, vehicle lifting, lug nut removal, wheel removal, socket selection, tire removal, tire mounting, tire balancing, wheel balancing, wheel replacement, lug nut replacement, vehicle lowering, interaction with a customer, and/or combinations thereof. One or more actions can be carried out by a person, a robot, and/or a combination thereof.

### User Interface for Scheduling, Tire Selection, and Other Activities

In some embodiments, a user interface facilitates scheduling of a tire change, tire selection, and/or other activities. A system can generate a user interface via an application program or module. The user interface can be used for creating and/or scheduling a tire change job. The user interface can include a portion of the user interface for obtaining vehicle information. The user interface can also include a portion for receiving a selection of a tire. The user interface can also include a portion for choosing a physical location for the changing of a tire. The user interface can also include a portion for selecting a date and time for scheduling the tire change job. The user interface can show available appointment dates and times. Times that are not available can be either not shown via the user interface or displayed but not selectable by a user.

The system can obtain customer order information through a respective website or device application. (An application can herein be described by as a software program that runs on a computer or mobile device.) A user may interact with a device (e.g., a phone, tablet, computer, etc.) that runs and thereby executes an application, for example that has been downloaded from an online application store. The application can generate interactive user interfaces for presentation to the user. Via a user interface of the system, a user can specify their vehicle make, model, and year. The system can prompt the user to provide three sets of information about their vehicle. Namely, the system can request user input on the make, model, and year of the user's respective vehicle. The information can then be stored within the database of the system. In response to receiving the requested information of the user's vehicle, a list of available tire types can be presented for selection based on the vehicle information received by the system.

The system can prompt the user for additional information, wherein the user selects and purchases a desired tire model(s) via the user interface. Additionally, the system can prompt the user to input which tire(s) is/are going to be replaced. (e.g., the front driver's side tire, front passenger side tire, rear passenger side tire, rear driver's side tire, another tire or tires, and/or combinations thereof) The system can store this set of information within the database and continue the user input process.

The system can request an additional information regarding which commercial location the user prefers to have their tires changed. The application can prompt the user for access to their device's (for example, a mobile a phone, or other mobile computing device) GPS (“Global Positioning System”) and/or location services, to locate the nearest locations where the user can have a tire change job performed. The system can determine, based on the location of the device, and provide a listing of one or more locations for the tire replacement.

Optionally, the user can deny access to the application, and instead manually input a location's address as well, to be provided with locations where a tire change job may be performed. The user interface can display nearby locations and their distances, and/or distances from the user's address or location, and then the user can select a desired location for the tire change job, and that information can then be stored in the system's database.

The system can prompt the user to input information about their desired appointment date and time. The system can check for available dates and store hours listed by the commercial location for appointment. Once identified, the system can present the appointment slots to the user in the respective device's interface. The system then can store the selected appointment date and time slot entered by the user into the database.

The system can also include other user interfaces to provide a user information about the status of a scheduled job. The system can also include additional user interfaces allowing other users to interact with the system, for example back-office or accounting, technical operators for control or monitoring of the vehicle lifting device, robotic apparatus, tire removal machine. The foregoing list of user interfaces is for exemplary purposes, and not meant to be limiting.

The system can include a user interface of a mobile application adapted for use on a mobile device. The mobile application can be configured to capture images of the vehicle. The user interface of the mobile device can instruct a user to capture one or more of a frontal image of the vehicle, an image for each of the wheel/tire of the vehicle, and an image of the license plate. The mobile application can submit the images for storage and subsequent processing by the system.

The system can receive an image of the tread of a tire and the system can determine that the tire needs to be replaced. For example, in some embodiments, one or more images can be received by the system and the system can determine tread depth by creating a 3-dimensional model of the tire from the image. Alternatively, a known object, such as a quarter, may be placed into the tread and an image taken by the application. The system may then identify the depth of the quarter in the tread based on the known size of the quarter. The system can compare the size of the quarter to the portion of coverage of tread. The determined portion of coverage of the quarter then can be used to calculate a distance from an intersecting line across the quarter to a perpendicular line to the edge of the quarter. While a quarter is used in the example, other objects may be used as well. Additionally, a ruler or other measurement device can be placed in the tread and an image of the measurement device can be taken. The system can then evaluate the image to determine the measurement markings of the device, and calculate the depth of the tread on the tire. The tread measurement can be stored by the system in the database, and associated with the vehicle id, and the respective tire (for example, front left, front right, rear right, and rear left).

Additionally, the system can determine a size of the tire and the brand and model of the tire. The system can determine a height of sidewall of the tire based on analysis of the image. The system may also determine the diameter of the wheel on which the tire is mounted.

Additionally, the system can determine the size of the tire by evaluating markings on the tire that identify the tire size. For example, an obtained image of the tire can depict letters on the tire, such as P215/65R15. The system can use optical character recognition to identify the lettering and symbols on the tire. These letters and symbols can be used by the system to identify the size of the tire. The first number can represent the section width of the tire, in millimeters. This can be the measurement of the tire at its thickest point. The second number can refer to the sidewall aspect ratio of the tire, ratio between tire width and height. The third number, can represent the diameter, in inches, of the wheel on which the tire is mounted. The system can parse the optically recognized characters to determine the tire size. The system can recommend, and/or generate a list of suitable tires for the vehicle based on the optically recognized characters. Additionally, a user interface of the system can provide a size of the tire to be selected. Moreover, the system can optically read other markings, characters or text on the vehicle, placards or tires indicating a particular tire size for use with the vehicle.

A example tire changing system can include various actions and/or means for carrying out actions, including but not limited to, job scheduling, vehicle check in, wheel assessment, vehicle lifting, lug nut removal, wheel removal, socket selection, tire removal, tire mounting, tire balancing, wheel balancing, wheel replacement, lug nut replacement, vehicle lowering, interaction with a customer, and/or combinations thereof. One or more actions can be carried out by a person, a robot, and/or a combination thereof.

### Wheel Assessment

In some embodiments, a tire changing system includes wheel assessment. Wheel assessment can include analysis of vehicle tire wear, suspension problem detection, missing lug nut detection, torque of lug nuts, and/or combinations thereof.

### Vehicle Tire Wear

The system can obtain imagery of vehicle tire tread using a digital camera. The system can determine whether a tire has uneven tread wear. The system can obtain a digital image of a tire showing the tread of the tire. The system can determine a first tread depth distance for a first portion of the tire tread. The system can determine a second tread depth distance for a second portion of the tire tread. The system can compare the first and second tread depth distance value to determine a tread depth variance value between the first and second tread depth portions. The system can determine an occurrence of uneven tire treadwear if the tread depth is greater than an allowable variance value.

For example, the system can determine a depth of tread for an inner and outer sides of the tire. The system can determine a first tread depth and a second tread depth (e.g., measured in millimeters or inches). The system can compare the first and second tread depth to determine a deviation distance. For example, the first tread depth may be 17 mm and the second tread depth may be 10 mm. The system can determine an absolute value for the calculation of the first tread depth minus the second tread depth. For example, |17 mm−10 mm|=7 mm. The system can compare the absolute value to an acceptable deviation value. For example, for the given make and model of the tire, or generally, is 7 mm deviation an acceptable value or within a normal wear range? If the system can determine that the wear pattern is not within acceptable range, then the system can indicate via an alert, or user interface, or system generated message, that the vehicle may have suspension problems. In one embodiment, in response to the determination of likely suspension problems the system can evaluate the tow angle of the wheels, or other suspension components. This vehicle wear detection process can be combined with other system can process as described herein.

### Suspension Problem Detection

In one embodiment, the tire gripper of the robotic apparatus may move the tire and the system may detect movement of the tire while attempting to slightly push a side of the tire inward and the opposite side of the tire outwards from the vehicle. The system can detect how far the tire is able to be pushed inward. The system can retrieve from a database a normal value of a travel distance. If the travel distance is determined to be greater than the normal value of the travel distance, the system can identify the suspension for that the particular vehicle wheel as have a probable suspension problem. For example, the if the travel distance is greater than 3-10 mm, than the vehicle likely has a suspension problem with that vehicle wheel. For example, the suspension problem could be with the ball joint, steering suspension, tie rods, etc. The system can provide an indication to the operator to further physically evaluate the suspension for the vehicle wheel. The system can record the amount of travel in the wheel and generate a report for indicating the travel amount. This suspension problem detection process may be combined with other system can process as described herein.

### Missing Lug Nut Detection

In one embodiment, the system can determine that a lug nut is missing from the lug nuts on a vehicle wheel. As indicated previously, the system can obtain images of the vehicle wheel and determine based on image processing that one of the lug nuts is missing. The system can identify the locations of each of the lug nuts in a lug nut pattern and determine a lug nut is missing from the identified location. The system can determine a variance in a location where a lug nut is supposed to be located. For example, the system can evaluate a grouping of pixels, such as a circle or square at a location of the lug nuts for a lug nut pattern. The system can process the grouping of pixels to identify whether the grouping of pixels is a lug nut or not. If the grouping of pixels is determined not to be a lug nut, then the system can indicate that a lug nut is missing for the particular location of the lug nut pattern. The system can provide an alert, message or other indication that a lug nut is missing from the vehicle wheel. The system can send a message to a supply or service department to request a replacement lug nut. The system can record information about the missing lug nut and its position. The system can still proceed with removal of the other lug nuts and remove the wheel for tire replacement. The system can then replace the lug nut that were removed, leaving the one lug nut missing. For example, the system can adjust the lug nut removal and replacement pattern due to the missing lug nut. This missing lug nut detection process can be combined with other system processes as described herein.

Some embodiments of the system of the present disclosure may further include a tire inside diameter detecting means for detecting a tire inside diameter from positional data or travel distance data of the three grip arms when the grip arms are gripping a tire. This allows not only acquisition of information from a tire identifier of a tire but also accurate measurement of the inside diameter of the tire. Hence, the possibility of rechecking the information on the tire identifier may further improve the accuracy of tire sorting.

Some embodiments of the system of the present disclosure may include a rotation radius changing means for changing the distance between the identifier reading means and the rotation axis of the holding unit and a detecting position control means for controlling the rotation radius changing means in such a manner as to move the identifier reading means to the position of the tire identifier based on the data of the tire inside diameter detected by the tire inside diameter detecting means. Thus, the rotation radius of the identifier reading means may be changed according to the tire size. Therefore, information may be read from the tire identifier even when there is a change in tire size.

Additional embodiments of the system of the present disclosure may provide a tire sorting apparatus that has a mounting means having a plurality of rotating bodies rotating in contact with the lower surface of the tire and a through hole through which the three grip arms may be extended toward the inner periphery of the tire.

In some embodiments of the system, devices to help in the compression of the tire stacks may be included. Some tire stacking systems, however, continue to rely heavily upon manual labor to accomplish the stacking of tires. For example, U.S. Pat. No. 5,697,294 issued to Keller et al. on Dec. 16, 1997, (“Keller I”) discloses an exemplary tire compression device and U.S. Pat. No. 5,816,142 issued to Keller et al. on Oct. 6, 1998, (“Keller II”) discloses another tire compression device intended for use with a forklift. Both Keller I and Keller II are incorporated by reference herein in their entireties. The Keller I and Keller II devices allow a preset load to compress a stack of tires as the stack is loaded into a truck trailer. Initially, the forklift elevates and supports the preset load. Then, once tires are stacked beneath the elevated load, the forklift allows the load to be lowered against a stack of tires. As a result, the load exerts a downward pressure on the stack of tires, thereby compressing the tires. Once the initial stack is compressed, additional uncompressed tires are loaded on top of the stack until the stack reaches the ceiling of the truck trailer. Then, the forks of the forklift are raised, partially releasing the pressure applied against the compressed portion of the stack and allowing it to expand, while compressing the previously uncompressed portion until the entire stack is equally compressed. This process is repeated, stack by stack, until the entire trailer is full of stacked, compressed tires. Other devices exist that load tires into a truck trailer and similarly compress tires within the trailer. In each of these cases, tires are maintained in compression by the storage and/or transportation vessel itself. However, no assurance exists that the vessel was designed or is suitable to maintain such loads. In fact, vessels are frequently damaged as a result of such use.

Various embodiments of the present disclosure include an apparatus for loading a tire onto a rack. The apparatus includes an automated tire conveyor, one or more scanners, and one or more robots to pick the tires off of the conveyor. The system may additionally include an apparatus for unloading a rack of tires, which includes a load station configured with a lift. The lift raises a rack of tires to a platform, where an unloader may manually or automatically move tires from the rack to a conveyor.

Further, some embodiments of the present disclosure include methods and systems for sorting and unloading tires into a store or warehouse for storage and sale as well. For example, the systems for sorting and unloading tires may include one or more automated conveyors, scanners, and storage structures. For example, in the sorting system, the scanner may read information off of incoming tires and communicate the tire information to a system of conveyors, which in turn directs each tire to a specific storage structure based upon the tire information (e.g., size, type, etc.).

In various embodiments, drive-in storage may also be included in the conveyor system configured with one or more computing systems, such as those described herein, to communicate with other loading or unloading systems of the system disclosed herein. For example, an unloading system within the system disclosed herein may communicate with drive-in storage when a first rack, which is being unloaded, is all or partially-empty such that a second rack may be delivered from the drive-in storage to the unloader. In another embodiment, an unloader or loader communicates with the drive-in storage when daily customer orders show that there is additional demand for a specific tire SKU (i.e., stock control unit). The rack may then be pulled from the drive-in-storage using, for example, a pull system applying lean manufacturing principles.

In some embodiments, the conveyor system may also include a system for loading, sorting, or unloading tires. The system may be automated or computer controlled. The system may be used in a plant that manufactures tires, and sorts and stores tires coming off the assembly line, and then dispenses tires in a desired order for shipment. Further, the system may also be used for loading and unloading articles or tires at a final destination, such as a tire shop or warehouse, where tires may be stored.

Although embodiments have been described with application to tires, embodiments also find application to transporting other articles. For example, boxes, solar panels, windows, construction equipment, car or automobile components, tractor components, pallets of products, etc. may be transported on the conveyors.

### Modular Systems

Embodiments of the disclosure include modular aspects. Modular aspects can enhance portability, for example by casing transport, assembly, disassembly, and/or relocation of a VRC. For example, a VRC can be modular, for example to case transport, assembly, disassembly, and/or relocation of a VRC. Many aspects of the disclosed VRCs can be implemented to enhance modularity. For example, various parts of a VRC can be attached with removable screws, bolts, and the like. Parts of a VRC can be attached as described herein, and any such attachment can be adapted to be reversible. Any disclosed attachment can be adapted to be reversible, to allow for easy assembly, disassembly, and/or transport. For example, modular aspects of a VRC can allow a VRC to be moved from one facility to another and/or to a different location within a facility.

In some embodiments, a VRC includes lightweight materials to enhance portability of the VRC and/or VRC components. For example, thin metal components, such as tubing and/or panels, decrease weight. As a further example, a panel can be made of acrylic and/or a different lightweight material instead of metal. Various components can be made with aluminum and/or other light metals, such as a panel, a pusher, a part of a pusher, a tube, a platform, a support, a shaft, a beam, a connector plate, and/or another part of the VRC.

In some embodiments, a small pusher is used to conserve material and reduce weight. For example, a short pusher can be used at a level near a platform. For example, a scissor pusher can extend from near a platform to a short height. The short height is sufficient to contact and push against a dolly carrying tires. In some embodiments, the pusher does not comprise a scissor mechanism. For example, one or more worm shafts can be used to push a pusher wall against a cargo, such as a set of tires. For example, a worm shaft and pusher wall can extend from near a platform to a short height. The short height is sufficient to contact and push against a dolly carrying tires.

In some embodiments, a support is adapted to enhance modularity of a VRC. For example, a support can be split into two or more sections to decrease the size of individual support pieces. For example, split I-beams can be used. A split I-beam is an I-beam that is divided into two or more sections. For example, an I-beam can be split into two, three, four, five, six, or more sections. For example, an I-beam can be split into two sections. For example, an I-beam can be split into three sections. For example, an I-beam can be split into four sections. For example, an I-beam can be split into five sections. For example, an I-beam can be split into six sections. For example, an I-beam can be split into more than six sections. Split I-beams decrease the size of individual I-beam sections. Split I-beams allow an I-beam to be disassembled and transported more easily than a single I-beam. Split I-beams can be assembled to produce a fully functional, full length I-beam. Split I-beams are easier to move than a single full length I-beam.

In some embodiments a housing is modular. Components of a housing and/or a housing structure can be reversibly assembled and/or reversibly disassembled. Tubes, such as steel tubes, can be reversibly attached to other parts of a VRC. Tubes can be split to decrease the size of individual parts of a housing and/or housing structure. A single full length tube can be assembled from split tubes. Tubes can be square tubes, such as steel square tubes. Panels can be reversibly attached to a VRC, such as panels that at least partially enclose the VRC. For example a panel, such as a steel or acrylic sheet metal panel can be reversibly attached to a VRC, for example to at least partially enclose the VRC. In some embodiments, a panel is split into to or more panel pieces, which decreases the size of individual panel parts.

In some embodiments, a platform is reversibly attached to a VRC. In some embodiments, a platform is split into to or more panel pieces, which decreases the size of individual platform parts.

In some embodiments, one or more anchor plates is reversibly attached to a surface, such as a floor, wall, and/or ceiling. In some embodiments an anchor plate is reversibly attached to a VRC. For example, a recessed footer anchor plate and/or a top floor anchor plate can be reversibly attached to a surface. For example, a recessed footer anchor plate and/or a top floor anchor plate can be reversibly attached to a VRC. For example, a recessed footer anchor plate and/or a top floor anchor plate can be reversibly attached to a surface and a VRC.

In some embodiments, a pusher or at least a part of a pusher is reversibly attached to a VRC. For example, a scissor mechanism, such as a ball screw driven scissor can be reversibly attached to a VRC. For example, scissor arms can be reversibly attached to a VRC.

In some embodiments, a door is reversibly attached to a VRC. For example, one or more roller doors can be reversibly attached to a VRC.

In some embodiments, a drive system, such as a dual roller chain drive system, can be reversibly attached to a VRC.

In some embodiments, at least one motor is reversibly attached to a VRC. For example, one, two, three, four, or more motors are reversibly attached to a VRC. One motor can be reversibly attached to a VRC. Two motors can be reversibly attached to a VRC. Three motors can be reversibly attached to a VRC. Four motors can be reversibly attached to a VRC. More than four motors can be reversibly attached to a VRC. In some embodiments, at least one 3-phase 208V motor is reversibly attached to a VRC.

In some embodiments, a vertical lift assembly can be reversibly attached to a VRC. For example, a motor, a drive shaft, a gearbox, an encoder, a roller cable, and/or a brake can be reversibly attached to a VRC. For example, a motor, an encoder, and a gearbox can be reversibly attached to a VRC.

In some embodiments, a part of a base, parts of a base, and/or a base can be reversibly attached to a VRC and/or a floor. In some embodiments, a base platform can be attached, detached, and/or moved from a VRC and/or a floor. In some embodiments, a base connector plate can be reversibly attached to a base beam. In some embodiments, a base connector plate can be reversibly attached to base platform. In some embodiments, a base connector plate can be removably attached to a support, such as an I-beam and/or a split I-beam.

In some embodiments, a tension assembly is reversibly attached to a VRC.

### Safety

In some embodiments, a VRC includes one or more safety features. For example, various safety features can protect workers. In some embodiments, a door blockage sensor can detect a door blockage and provide an alert, such as a light, a flashing light, and/or an audible signal, such as an alarm. In some embodiments, a pusher comprises an overpressure sensor that senses a blockage of a pusher and provides a signal, such as a light, a flashing light, and/or an audible signal, such as an alarm. In some embodiments, a VRC includes a motor overpressure sensor that senses when a motor experiences too much resistance and provides a signal, such as a light, a flashing light, and/or an audible signal, such as an alarm. In some embodiments, a sensor detects if a cargo, such as a set of tires, does not properly exit the VRC, such as if a dolly with tires rolls back into the VRC, and provides a signal, such as a light, a flashing light, and/or an audible signal, such as an alarm. In some embodiments, a VRC comprises a sensor and/or signal that a door is opening and/or closing and provides a signal, such as a light, a flashing light, and/or an audible signal, such as an alarm. In some embodiments, a VRC comprises a sensor and/or signal that alerts when a pusher is extending and/or retracting and provides a signal, such as a light, a flashing light, and/or an audible signal, such as an alarm.

A VRC can include one or more shutoff buttons. A shutoff button can be located anywhere on, in, and/or around a VRC. For example, a shutoff signal can be located inside a VRC, which can enable a user inside the VRC to shut off the VRC. As a further example, a shutoff signal can be located inside a VRC near a door. For example, a shutoff signal can be located outside a VRC, which can enable a user outside the VRC to shut off the VRC. As a further example, a shutoff signal can be located outside a VRC near a door. As another example a shutoff button can be located outside a VRC and near a control panel.

In some embodiments, a VRC is capable of slow acceleration and/or deceleration of a platform. In some embodiments, a control panel is used to control acceleration and/or deceleration of a platform.

In some embodiments, a VRC is capable of slow acceleration and/or deceleration of a pusher. In some embodiments, a control panel is used to control acceleration and/or deceleration of a pusher.

In some embodiments, a floor elevation sensor alerts when a platform has reached a certain height and provide a signal, such as a light, a flashing light, and/or an audible signal, such as an alarm. In some embodiments, a floor elevation sensor causes a platform to stop at a certain height. In some embodiments, a floor elevation sensor is not needed. For example, an encoder can be programmed to cause a platform to stop at a certain height, eliminating the need for a floor elevation sensor. In some embodiments, a signal is provided when a platform reaches and/or nears a programmed height, such as a light, a flashing light, and/or an audible signal, such as an alarm.

In some embodiments, a VRC comprises one or more pressure and/or weight sensors. For example, a VRC can include a sensor that detects when something is inside the VRC, for example on a platform. For example, a pressure and/or weight sensor can detect when a tire, a set of tires, a dolly, and/or a person are inside the VRC. Because a weight of a tire can be known, a pressure and/or weight sensor can detect how many and which type of tire is located in the VRC. For example, a pressure and/or weight sensor can detect if a dolly and/or a dolly holding one or more tires of a known weight is inside the VRC. A pressure and/or weight sensor can detect if a person is located within the VRC with or without a dolly and/or one or more tires.

### Control Panel

In some embodiments, a VRC comprises a control panel, which can be UL-certified. A control panel can comprise a touch screen display. A touch screen display can allow a user to input various programmable parameters to control the VRC. A touch screen can also display such programmable parameters. For example, a user can input a programmed height at which a platform stops, and/or at which a platform decelerates and/or accelerates. A control panel can be used with an encoder to stop, decelerate, and/or accelerate a platform. A control panel and encoder can cause a platform to stop, decelerate, and/or accelerate at a height within about 1/32 of an inch of the programmed height.

In some embodiments, a control panel controls extension and/or retraction of a pusher. For example, a control panel can be used to control how frequently a pusher extends and/or retracts, for example at every stop of a platform and/or only when desired by a user, such as occasionally at a stop of a platform.

In some embodiments, a control panel controls opening and/or closing of a door. For example, a control panel can be used to control how frequently a door opens and/or closes, for example at every stop of a platform and/or only when desired by a user, such as occasionally at a stop of a platform.

In some embodiments, a control panel can be monitored and/or programmed remotely. For example, a control panel can be programmed remotely from a location within the same facility as a VRC is located and/or from a different facility. For example, a control panel can be monitored remotely from a location within the same facility as a VRC is located and/or from a different facility.

In some embodiments, a control panel can be programmed to control all or nearly all movement of a VRC. For example, routines can be programmed to control raising and lowering of a platform, opening and/or closing of one or more doors, extension and/or retraction of a pusher, when a signal, such as a light and/or an alarm, is activated and/or deactivated. A control panel can be used to cause a platform to stop within 1/32 of an inch of a desired height.

In some embodiments, a control panel comprises a programmable logic controller (PLC). A PLC is a control device normally used in industrial control applications that employs the hardware architecture of a computer and a relay ladder diagram language. It is a programmable microprocessor-based device that is generally used in manufacturing to control assembly lines and machinery as well as many other types of mechanical, electrical and electronic equipment. A PLC can be programmed in an IEC 61131 programming language. A PLC can enable individual control of each of the components in the system during testing and normal operation.

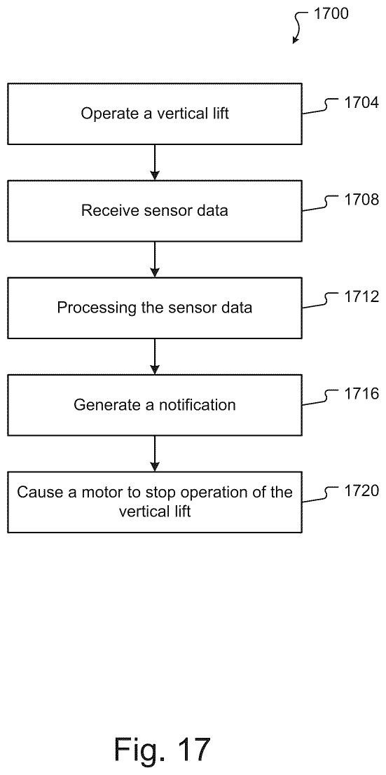

FIG. 17 depicts a method 1700 that may be used, for example, for operating a vertical lift.

The method 1700 (and/or one or more steps thereof) may be carried out or otherwise performed, for example, by at least one processor. The at least one processor may be the same as or similar to the processor(s) 1604 of the computing device 1602 described above. A processor other than any processor described herein may also be used to execute the method 1700. The at least one processor may perform the method 1700 by executing elements stored in a memory such as the memory 1606. The elements stored in memory and executed by the processor may cause the processor to execute one or more steps of a function as shown in method 1700. One or more portions of a method 1700 may be performed by the processor executing any of the contents of memory, such as sensor data processing 1620 and/or notification generation 1624.

The method 1700 comprises operating a vertical lift (step 1704). The vertical lift may be the same as or similar to the vertical lift 100. Operating the vertical lift may include receiving user input to operate the vertical lift. For example, a user may input instructions via a user interface such as the user interface 1610 to begin use of the vertical lift. The user may input the instructions after positioning a set of tires on a platform such as the platform 106 of the vertical lift. Operating the vertical lift may include the steps 1804-1832 of the method 1800 described in FIG. 1800.

The method 1700 also comprises receiving sensor data (step 1708). The sensor data may be received from a sensor such as the sensor 1628. The sensor data may include, for example, pressure sensor data, acceleration sensor data, force sensor data, and/or torque sensor data. The sensor may be configured to sense at least one value and yield the sensor data. The sensor may correspond to transducers that are configured to convert physical phenomena into an electrical signal that is capable of being processed by the controller or the processor of the computing device. Non-limiting examples of sensor include gyroscopic sensor, pressure sensor, accelerometers, strain gauges, impact sensor, vibration detectors, etc. The sensor may include one or more or any combination of components that are electrical, mechanical, electro-mechanical, magnetic, electromagnetic, or the like. In some embodiments, the sensor may include a memory for storing sensor data. In still other examples, the sensor may output signals (e.g., sensor data) to one or more sources (e.g., the controller, the computing device, etc.) and may be stored in memory such as the memory 1606.

The method 1700 also comprises processing the sensor data (step 1712). The sensor data may be processed by a processor such as the processor 1604 executing a sensor data processing such as the sensor data processing 1620 to process the sensor data (received in, for example, the step 1708). The processed sensor data may include, for example, pressure value(s), acceleration value(s), force value(s), vibration value(s), etc.

The method 1700 also comprises generating a notification (step 1716). The notification may be generated by the processor using a notification generation such as the notification generation 1622 to generate a notification when the processed sensor data meets or exceeds a predetermined threshold. It will be appreciated that in some embodiments, the notification may be generated when the processed sensor data is below the predetermined threshold. In still other embodiments, the notification may be generated when a difference between the processed sensor data and an expected sensor data meets or exceeds the predetermined threshold. The notification may be an audible and/or a visual notification (which may be displayed on, for example, the user interface).

It will be appreciated that in some embodiments, the method 1700 may not include the step 1716.

The method 1700 also comprises causing a motor to stop operation of the vertical lift (step 1720). Any one of the motors (e.g., a first motor such as the first motor 116, a second motor such as the second motor 118, a motor such as the motor 130, a pusher motor such as the pusher motor 228) may be stopped when the processed sensor data meets or exceeds a predetermined threshold. For example, one or more sensors may detect if there is an obstruction at one of a first door such as the first door 110 or a second door such as the second door 112. If such obstruction is detected, the first motor or the second motor may be stopped and a notification may be communicated to a user.

It will be appreciated that in some embodiments, the method 1700 may not include the step 1720.

The present disclosure encompasses embodiments of the method 1700 that comprise more or fewer steps than those described above, and/or one or more steps that are different than the steps described above.

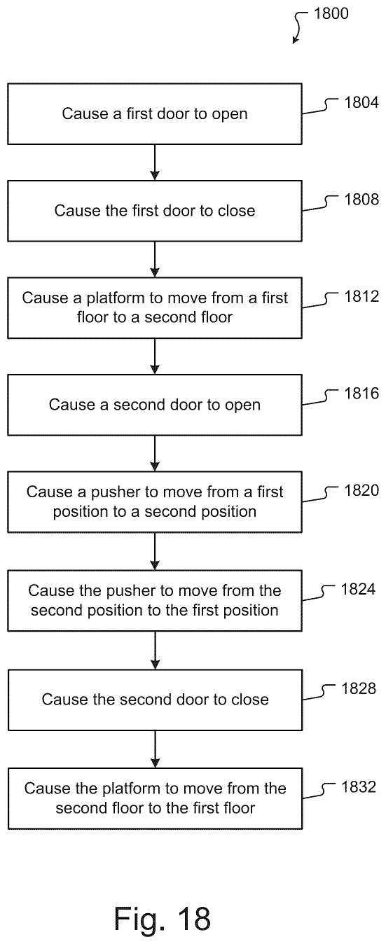

FIG. 18 depicts a method 1800 that may be used, for example, for operating a vertical lift.

The method 1800 (and/or one or more steps thereof) may be carried out or otherwise performed, for example, by at least one processor. The at least one processor may be the same as or similar to the processor(s) 1604 of the computing device 1602 described above. A processor other than any processor described herein may also be used to execute the method 1800. The at least one processor may perform the method 1800 by executing elements stored in a memory such as the memory 1606. The elements stored in memory and executed by the processor may cause the processor to execute one or more steps of a function as shown in method 1800. One or more portions of a method 1800 may be performed by the processor executing any of the contents of memory, such as sensor data processing 1620 and/or notification generation 1624.

The method 1800 comprises causing a first door to open (step 1804). The first door may be the same as or similar to the first door 110 of a vertical lift such as the vertical lift 100. The first door may be opened by a first motor such as the first motor 116 based on instructions sent to the motor by a processor such as the processor 1604 or a controller such as the controller 1624. The first door may default to the open position, or may move to the open position based on user input.

The method 1800 also comprises causing the first door to close (step 1808). While the first door is open, a user may insert or position a set of tires on a platform such as the platform 106 of the vertical lift. After the set of tires is in place, the user may input user input via a user interface such as the user interface 1610 to cause the first door to close. The first door may be closed by the first motor.

The method 1800 also comprises causing the platform to move from a first floor to a second floor (step 1812). The platform is moved from the first floor to the second floor by a vertical lift assembly such as the vertical lift assembly 130. More specifically a pair of roller chains such as the pair of roller chains 158 may be connected to the platform by one or more connector plates such as the connector plates 164. The pair of roller chains are rotated by a drive shaft such as the drive shaft 150 driven by a motor such as the motor 152, which moves the platform between the first floor and the second floor. The motor may be automatically operated based on instructions received from, for example, the processor or the controller. The instructions may include instructions for causing the motor to speed up to a full speed when the platform is initially moved, then reducing the speed when the platform is closer to the second floor. The instructions may also cause the motor to stop when a bottom of the platform is level with a surface of the second floor. Confirmation that the second floor has been reached may be received from one or more sensors such as, for example, a limit switch positioned on the second floor. It will be appreciated that any sensor may be used to validate that the second floor has been reached by the platform such as, for example, any proximity sensor, an optical sensor, an encoder, etc.

The method 1800 also comprises causing a second door to open (step 1816). The second door may be the same as or similar to the second door 112. The second t door may be opened by a second motor such as the second motor 118 based on instructions received from, for example, the processor or the controller.

The method 1800 also comprises causing a pusher to move from a first position to a second position (step 1820). The pusher may be the same as or similar to the pusher 252 and may be moveable between a first position and a second position by a pusher assembly such as the pusher assembly 132. As previously described, the pusher assembly includes a pair of scissor arms driven by a pusher motor such as the pusher motor 228. More specifically, the pusher motor rotates a screw such as the screw 232 that rotates a threaded nut such as the threaded nut 240 attached to a scissor arm platform such as the scissor arm platform 106. When the threaded nut—and thus the scissor arm platform linearly moves up and down the screw, the pair of scissor arms are moved between an extended position and a contracted position in a horizontal direction. Thus, the motion of the pair of scissor arms moves the pusher between the first position (e.g., the contracted position) and the second position (e.g., the extended position). Thus, when the pusher moves to the second position, the pusher moves the set of tires to the second position and out of the platform of the vertical lift. The pusher assembly may operate automatically based on instructions received from, for example, the processor or the controller.

The method 1800 also comprises causing the pusher to move from the second position to the first position (step 1824). Once the set of tires is outside of the platform, the motor receives instructions from the processor or the controller to rotate the screw in the opposite direction to move the pusher from the second position to the first position.

The method 1800 also comprises causing the second door to close (step 1828). The second door may be closed by the second motor based on instructions received from the processor or the controller. The second door may not be closed until one or more sensors such as the sensors 1628 sense that the set of tires is no longer on the platform and is not obstructing a path of the second door.

The method 1800 also comprises causing the vertical lift to move from the second floor to the first floor (step 1832). Causing the vertical lift to move from the second floor to the first floor may include instructing the motor to rotate the drive shaft in an opposite direction based on instructions received from the processor or the controller. The instructions may include instructions for causing the motor to speed up to a full speed when the platform is initially moved, then reducing the speed when the platform is closer to the first floor. The instructions may also cause the motor to stop when a bottom of the platform is level with a surface of the first floor. Confirmation that the first floor has been reached may be received from one or more sensors such as, for example, a limit switch positioned on the first floor.

The present disclosure encompasses embodiments of the method 1800 that comprise more or fewer steps than those described above, and/or one or more steps that are different than the steps described above.

As noted above, the present disclosure encompasses methods with fewer than all of the steps identified in FIGS. 17 and 18 (and the corresponding description of the methods 1700, 1800), as well as methods that include additional steps beyond those identified in FIGS. 17 and 18 (and the corresponding description of the method 1700, 1800). The present disclosure also encompasses methods that comprise one or more steps from one method described herein, and one or more steps from another method described herein. Any correlation described herein may be or comprise a registration or any other correlation.

The concepts illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications which do not depart from the spirit and scope of the disclosure are deemed to be covered by the disclosure.

The foregoing discussion has been presented for purposes of illustration and description. The foregoing is not intended to limit the disclosure to the form or forms disclosed herein. In the foregoing Detailed Description, for example, various features are grouped together in one or more embodiments for the purpose of streamlining the disclosure. The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

Moreover, though the present disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

What is claimed:

1. A vertical reciprocating conveyer comprising:
a platform configured to receive and support one or more tires;
a vertical lift assembly configured to move the platform between a first floor and a second floor; and
a pusher assembly configured to move the one or more tires from the platform to a surface of the second floor,
wherein at least one component of the vertical reciprocating conveyer is adapted to enhance portability.

2. The vertical reciprocating conveyer of claim 1, further comprising a processor and memory storing data thereon that, when processed by the processor, cause the processor to:
receive user input to move the one or more tires from the first floor to the second floor;
cause the vertical lift assembly to move the platform from the first floor to the second floor;
cause the pusher assembly to move the one or more tires from the platform to the second floor; and
cause the vertical lift assembly to move the platform from the second floor to the first floor.

3. The vertical reciprocating conveyer of claim 1, wherein at least one I-beam is a split I-beam.

4. The vertical reciprocating conveyer of claim 1, wherein the vertical lift assembly comprises a dual roller chain drive system and a vertical lift frame, wherein the vertical lift frame includes at least two split I-beams.

5. The vertical reciprocating conveyer of claim 4, wherein the vertical lift assembly further comprises a motor configured to rotate a drive shaft, the draft shaft coupled to dual roller chains connected to the platform.

6. The vertical reciprocating conveyer of claim 5, wherein the dual roller chains are connected to the platform via a corresponding connector plate and a pair of rollers, wherein the pair of rollers are positioned within two flanges of each I-beam to align the platform with the at least two I-beams.

7. The vertical reciprocating conveyer of claim 6, wherein the vertical lift assembly further comprises at least one stabilizer positioned near a top of the platform, wherein the stabilizer includes at least two rollers positioned on either side of a flange of a corresponding I-beam.

8. The vertical reciprocating conveyer of claim 1, wherein the pusher assembly comprises a pair of scissor arms configured to move a pusher between a first compressed position and a second extended position and a motor configured to drive the pair of scissor arms.

9. The vertical reciprocating conveyer of claim 1, further comprising one or more sensors for sensing a condition of the vertical reciprocating conveyer.

10. The vertical reciprocating conveyer of claim 9, wherein the condition includes at least one of an obstruction, a pressure exceeding a pressure threshold, or a force exceeding a force threshold.

11. The vertical reciprocating conveyer of claim 1, further comprising a first door positioned at the first floor and a second door positioned at the second floor.

12. A vertical reciprocating conveyer system for moving one or more tires comprises:
a vertical reciprocating conveyer comprising:
a platform configured to receive and support the one or more tires;
a vertical lift assembly configured to move the platform between a first floor and a second floor;
a pusher assembly configured to move the one or more tires from the platform to a surface of the second floor;
one or more sensors for sensing a condition of the vertical reciprocating conveyer;
at least one processor
at least one encoder; and
at least one memory storing instructions for execution by the at least one processor that, when executed, cause the at least one processor to:
receive sensor data from the one or more sensors;
cause at least one of the vertical lift assembly or the pusher assembly to stop operation when the sensor data meets or exceeds a threshold,
wherein the encoder stops the platform at a specified height without the need for a sensor to detect platform height.

13. The vertical reciprocating conveyer system of claim 12, further comprising a processor and memory storing data thereon that, when processed by the processor, cause the processor to:
receive user input to move the one or more tires from the first floor to the second floor;
cause the vertical lift assembly to move the platform from the first floor to the second floor;
cause the pusher assembly to move the one or more tires from the platform to the second floor; and
cause the vertical lift assembly to move the platform from the second floor to the first floor.

14. The vertical reciprocating conveyer system of claim 12, wherein the encoder stops the platform within about 1/32 of an inch of the specified height.

15. The vertical reciprocating conveyer system of claim 12, wherein the vertical lift assembly comprises a dual roller chain drive system and a vertical lift frame, wherein the vertical lift frame includes at least two I-beams.

16. The vertical reciprocating conveyer system of claim 15, wherein the vertical lift assembly further comprises a motor configured to rotate a drive shaft, the draft shaft coupled to dual roller chains connected to the platform.

17. The vertical reciprocating conveyer system of claim 16, wherein the dual roller chains are connected to the platform via a corresponding connector plate and a pair of rollers, wherein the pair of rollers are positioned within two flanges of each I-beam to align the platform with the at least two I-beams.

18. The vertical reciprocating conveyer system of claim 17, wherein the vertical lift assembly further comprises at least one stabilizer positioned near a top of the platform, wherein the stabilizer includes at least two rollers positioned on either side of a flange of a corresponding I-beam.

19. The vertical reciprocating conveyer system of claim 12, wherein the pusher assembly comprises a pair of scissor arms configured to move a pusher between a first compressed position and a second extended position and a motor configured to drive the pair of scissor arms.

20. A method for operating a vertical reciprocating conveyer, the method comprising:
receiving user input to begin operation of a vertical reciprocating conveyer, the vertical reciprocating conveyer having a platform configured to receive and support the one or more tires, a vertical lift assembly configured to move the platform between a first floor and a second floor, a pusher assembly configured to move the one or more tires from the platform to a surface of the second floor,
moving the one or more tires onto the platform using a robot;
moving the platform from the first floor to the second floor using the vertical lift assembly;
moving the one or more tires from the platform to the second floor using the pusher assembly;
moving the one or more tires away from the platform using the robot; and
moving the platform from the second floor to the first floor using the vertical lift assembly.
